(19) United States
(12) Patent Application Publication
(10) Pub. No.: US 2012/0113159 A1
(43) Pub. Date: May 10, 2012

(54) STEREOSCOPIC DISPLAY APPARATUS AND DISPLAY METHOD FOR STEREOSCOPIC DISPLAY APPARATUS

(75) Inventors: Atsuhiro Chiba, Tokyo (JP); Yoshihisa Sato, Saitama (JP); Yoshiki Okamoto, Kanagawa (JP); Tetsuyuki Yoshida, Tokyo (JP); Sho Sakamoto, Tokyo (JP)

(73) Assignee: SONY CORPORATION, Tokyo (JP)

(21) Appl. No.: 13/286,735

(22) Filed: Nov. 1, 2011

(30) Foreign Application Priority Data
Nov. 9, 2010 (JP) 2010-250698

(51) Int. Cl. G09G 5/10

(52) U.S. Cl. 345/690

(57) ABSTRACT

A display apparatus includes: a display section that is driven to perform line sequential scanning and display a plurality of different viewpoint video images; a backlight that includes a plurality of sub-light emitting areas separated in the line sequential scanning direction; a light barrier that has a plurality of open/close unit groups each of which is formed of a plurality of open/close units, the open/close units in different groups opened or closed at different timings; and a backlight controller that controls light emission from the sub-light emitting areas in the backlight in synchronization with the line sequential scanning in the display section, wherein the backlight controller separately controls intensities of the light emitted from the sub-light emitting areas.

### FIELD

The present disclosure relates to a stereoscopic display apparatus that allows stereoscopic display based on a parallax barrier and a display method for the stereoscopic display apparatus.

### BACKGROUND

A display apparatus that allows stereoscopic display (stereoscopic display apparatus) has recently drawn attention. In stereoscopic display, video images for the right eye and video images for the left eye between which parallax is present (in which viewpoints are different) are displayed, and when a viewer looks at the right and left video images with the right and left eyes, respectively, the viewer can recognize them as stereoscopic video images that give a sense of depth. Further, there is a display apparatus having been so developed that three or more types of video image among which parallax is present are displayed to provide the viewer with more natural stereoscopic video images.

Such stereoscopic display apparatus are roughly classified into those that need dedicated eyeglasses and those that need no dedicated eyeglasses. Dedicated eyeglasses are cumbersome for the viewer, and stereoscopic display apparatus that need no dedicated eyeglasses are desired. Examples of the display apparatus that need no dedicated eyeglasses employ a method based on a lenticular lens and a method based on a parallax barrier. In the two methods described above, a plurality of video images among which parallax is present (viewpoint video images) are simultaneously displayed, and the plurality of video images are differently recognized depending on the relative positional (angular) relationship between the display apparatus and the viewpoint of the viewer. When such a display apparatus displays a plurality of viewpoint video images, effective video image resolution is lower than the resolution of the display apparatus itself, such as a CRT (cathode ray tube) and a liquid crystal display apparatus, that is, the resolution of the display apparatus divided by the number of viewpoints, disadvantageously resulting in decrease in image quality.

To solve the problem described above, a variety of studies have been conducted. For example, JP-A-2007-114793 proposes a parallax barrier-based display apparatus whose resolution is effectively improved by switching the state of each barrier disposed along a display surface between a light transmitting state (open state) and a light blocking state (closed state) in a time division manner.

### SUMMARY

It is generally desired for a display apparatus to provide uniform brightness across the display surface. JP-A-2007-114793, however, does not describe uniformity of the brightness at all.

It is desirable to provide a stereoscopic display apparatus that can ensure uniform brightness across a display surface and a display method for the stereoscopic display apparatus.

A display apparatus according to an embodiment of the present disclosure includes: a display section, a backlight, a light barrier, and a backlight controller. The display section is driven to perform line sequential scanning and display a plurality of different viewpoint video images. The backlight includes a plurality of sub-light emitting areas separated in the line sequential scanning direction. The light barrier has a plurality of open/close unit groups each of which is formed of a plurality of open/close units, and the open/close units in different groups are opened or closed at different timings. The backlight controller controls light emission from the sub-light emitting areas in the backlight in synchronization with the line sequential scanning in the display section. The backlight controller separately controls intensities of the light emitted from the sub-light emitting areas.

A display method for a display apparatus according to another embodiment of the present disclosure includes: opening or closing a plurality of open/close units in a light barrier on an open/close unit group basis in a time division manner, displaying a plurality of different viewpoint video images in positions corresponding to the open/close units that are open by performing line sequentially scanning, and causing a plurality of sub-light emitting areas in a backlight separated in the line sequential scanning direction to emit light having individually set emitted light intensities in synchronization with the line sequential scanning.

In the display apparatus and the display method for the display apparatus according to the embodiments of the present disclosure, a plurality of different viewpoint video images displayed in the display section by performing line sequential scanning are stereoscopically displayed by opening or closing a plurality of open/close units on an open/close group basis. In this process, a plurality of sub-light emitting areas in the backlight emit light having individually set emitted light intensities in synchronization with the line sequential scanning in the display section.

In the display apparatus according to the embodiment of the present disclosure, for example, the intensity of the light emitted from each of the sub-light emitting areas is preferably set in accordance with the temporal relationship between a period during which the corresponding open/close unit is open and a period during which the sub-light emitting area emits light. Further, for example, the intensity of light emitted from each of the sub-light emitting areas is desirably so set that when uniform video images are displayed in the display section and a viewer views the video images displayed by the display apparatus, the viewer recognizes uniform brightness across a display surface.

For example, the plurality of open/close units may be so disposed to extend in the line sequential scanning direction, and the open/close unit groups may be alternately arranged in a direction that intersects the line sequential scanning direction. Further, the plurality of open/close units may be separated in the line sequential scanning direction and form different open/close unit groups. In this case, the temporal relationship can be a relationship between a period during which each of the open/close units is open and a period during which the sub-light emitting area corresponding to the position of the open/close unit emits light. For example, the light barrier desirably opens or closes the open/close units on the open/close unit group basis in a time division manner, and the display section desirably sequentially displays video images in positions corresponding to the open/close units that are open.

For example, the backlight controller preferably controls the intensity of the light emitted from each of the sub-light emitting areas based on a light emission duty ratio.

For example, the display apparatus preferably further includes an intensity parameter set holder that holds one or more intensity parameter sets used to set the intensities of the light emitted from the plurality of sub-light emitting areas. In this case, for example, the display apparatus may further include a temperature sensor, and the backlight controller may select one of the plurality of intensity parameter sets based on a detection result from the temperature sensor and control the intensity of the light emitted from each of the sub-light emitting areas based on the selected intensity parameter set. Further, for example, the display apparatus may further include a temperature sensor and a light barrier controller that controls open/close operation of each of the open/close unit groups in the light barrier, and the light barrier controller may control a timing at which each of the open/close unit groups is opened or closed based on a detection result from the temperature sensor.

For example, the period during which each of the open/close units is open preferably includes a first transition period during which the state of the open/close unit changes from a blocking state to an open state, a fully open period during which the open/close unit is kept open, and a second transition period during which the state of the open/close unit changes from the open state to the blocking state, and the intensity of the light emitted from each of the plurality of sub-light emitting areas is desirably set in accordance with the length of the first transition period, the length of the fully open period, the length of the second transition period, how optical transmittance of the open/close unit changes in the first transition period, and how the optical transmittance of the open/close unit changes in the second transition period.

For example, the display section may be disposed between the backlight and the light barrier. Further, for example, the light barrier may be disposed between the backlight and the display section.

In the display apparatus and the display method for the display apparatus according to the embodiments of the present disclosure, a plurality of sub-light emitting areas emit light having individually set emitted light intensities, whereby the brightness across the display surface can be uniform.

### BRIEF DESCRIPTION OF THE DRAWINGS

FIG. 1 is a block diagram showing an example of the configuration of a stereoscopic display apparatus according to a first embodiment of the present disclosure;

FIGS. 2A and 2B describe an example of configuration of the stereoscopic display apparatus shown in FIG. 1;

FIG. 3 is a block diagram showing an example of the configuration of a display driver and a display section shown in FIG. 1;

FIG. 4 is a circuit diagram showing an example of the configuration of each pixel shown in FIG. 3;

FIGS. 5A and 5B describe an example of the configuration of a backlight shown in FIG. 1;

FIGS. 6A and 6B describe an example of the configuration of a liquid crystal barrier shown in FIG. 1;

FIG. 7 diagrammatically shows an example of how the liquid crystal barrier shown in FIG. 1 operates in a stereoscopic display mode;

FIGS. 8A to 8C diagrammatically show an example of how the display section and the liquid crystal barrier shown in FIG. 1 operate;

FIGS. 9A and 9B also diagrammatically show an example of how the display section and the liquid crystal barrier shown in FIG. 1 operate;

FIGS. 10A to 10D are timing charts showing an example of how the stereoscopic display apparatus shown in FIG. 1 operates;

FIGS. 11A to 11G are other timing charts showing an example of how the stereoscopic display apparatus shown in FIG. 1 operates;

FIGS. 12A and 12B diagrammatically show an example of how the stereoscopic display apparatus shown in FIG. 1 operates;

FIGS. 13A to 13G are timing charts showing an example of how a stereoscopic display apparatus according to Comparative Example operates;

FIGS. 14A and 14B diagrammatically show an example of how the stereoscopic display apparatus according to Comparative Example operates;

FIG. 15 is a block diagram showing an example of the configuration of a stereoscopic display apparatus according to a second embodiment of the present disclosure;

FIGS. 16A to 16D are timing charts showing an example of how the stereoscopic display apparatus shown in FIG. 15 operates;

FIGS. 17A and 17B diagrammatically show an example of how the stereoscopic display apparatus shown in FIG. 15 operates;

FIG. 18 is a block diagram showing an example of the configuration of a stereoscopic display apparatus according to a third embodiment of the present disclosure;

FIGS. 19A to 19D are timing charts showing an example of how the stereoscopic display apparatus shown in FIG. 18 operates;

FIG. 20 describes an example of configuration of a liquid crystal barrier according to a fourth embodiment of the present disclosure;

FIG. 21 diagrammatically shows an example of how the liquid crystal barrier shown in FIG. 20 operates in the stereoscopic display mode;

FIGS. 22A to 22D are timing charts showing an example of how the stereoscopic display apparatus according to the fourth embodiment operates;

FIGS. 23A and 23B diagrammatically show an example of how the stereoscopic display apparatus according to the fourth embodiment operates;

FIGS. 24A and 24B describe an example of configuration of a stereoscopic display apparatus according to a variation;

FIGS. 25A and 25B diagrammatically show an example of how the stereoscopic display apparatus according to the variation operates;

FIG. 26 is a plan view showing an example of the configuration of a backlight according to another variation;

FIGS. 27A and 27B are plan views showing examples of the configuration of liquid crystal barriers according to other variations;

FIGS. 28A to 28C diagrammatically show an example of how a display section and a liquid crystal barrier according to another variation operate; and

FIGS. 29A to 29D are timing charts showing an example of how a stereoscopic display apparatus according to another variation operates.

### DETAILED DESCRIPTION

Embodiments of the present disclosure will be described below in detail with reference to the drawings. The description will be made in the following order.

1. First Embodiment

2. Second Embodiment

3. Third Embodiment

4. Fourth Embodiment

### 1. First Embodiment

### [Example of Configuration]

### (Example of Overall Configuration)

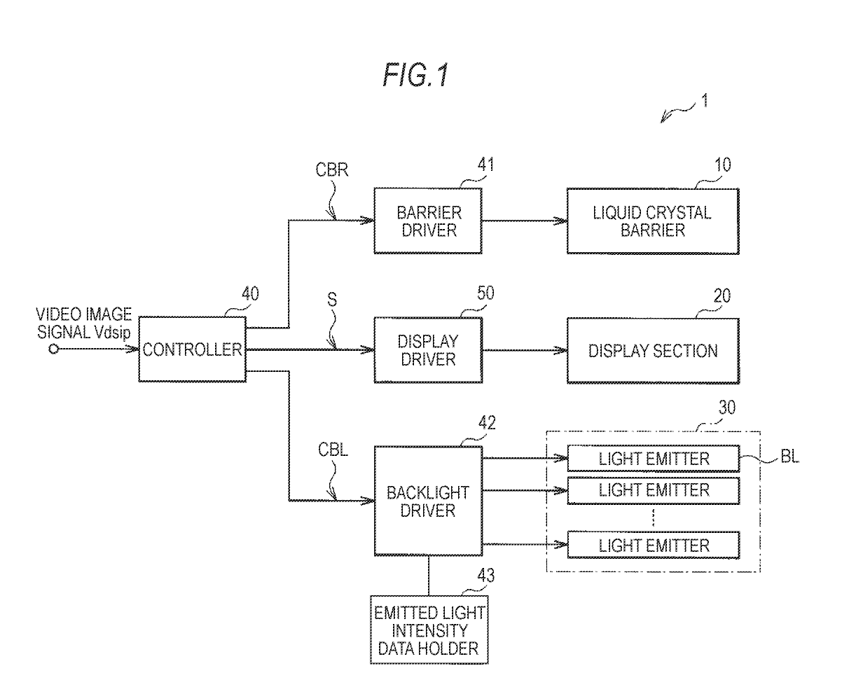

FIG. 1 shows an example of the configuration of a stereoscopic display apparatus according to an embodiment of the present disclosure. A display method for the stereoscopic display apparatus according to the embodiment of the present disclosure will also be described below because the method is embodied in the present embodiment. A stereoscopic display apparatus 1 includes a controller 40, a display driver 50, a display section 20, a backlight driver 42, a backlight 30, an emitted light intensity data holder 43, a barrier driver 41, and a liquid crystal barrier 10.

The controller 40 is a circuit that supplies control signals to the display driver 50, the backlight driver 42, and the barrier driver 41 based on an externally supplied video image signal Vdisp and controls the drivers to operate in synchronization with one another. Specifically, the controller 40 supplies the display driver 50 with a video image signal S based on the video image signal Vdisp, supplies the backlight driver 42 with a backlight control signal CBL, and supplies the barrier driver 41 with a barrier control signal CBR. When the stereoscopic display apparatus 1 displays video images stereoscopically, the video image signal S is formed of video image signals SA and SB, each of which contains a plurality of (six in this example) viewpoint video images, as will be described later.

The display driver 50 drives the display section 20 based on the video image signal S supplied from the controller 40. The display section 20 displays video images by performing line sequential scanning. In this example, video images are displayed by driving liquid crystal display devices to modulate light emitted from the backlight 30.

The backlight driver 42 drives the backlight 30 based on the backlight control signal CBL supplied from the controller 40. The backlight 30 has a function of emitting light in the form of surface emission to the display section 20 and is formed of a plurality of light emitters BL (light emitters BL1 to BL10, which will be described later) capable of emitting light independent from one another. The emitted light intensity data holder 43 holds emitted light intensity data 44 used to instruct the light emitters BL to output intended emitted light intensities J (emitted light intensities J1 to J10, which will be described later), and the backlight driver 42 controls the light emission from the light emitters BL based on the emitted light intensity data 44.

The barrier driver 41 drives the liquid crystal barrier 10 based on the barrier control signal CBR supplied from the controller 40. The liquid crystal barrier 10 includes a plurality of open/close units 11 and 12 (which will be described later) based on a liquid crystal material and has a function of transmitting or blocking light having exited from the backlight 30 and passed through the display section 20.

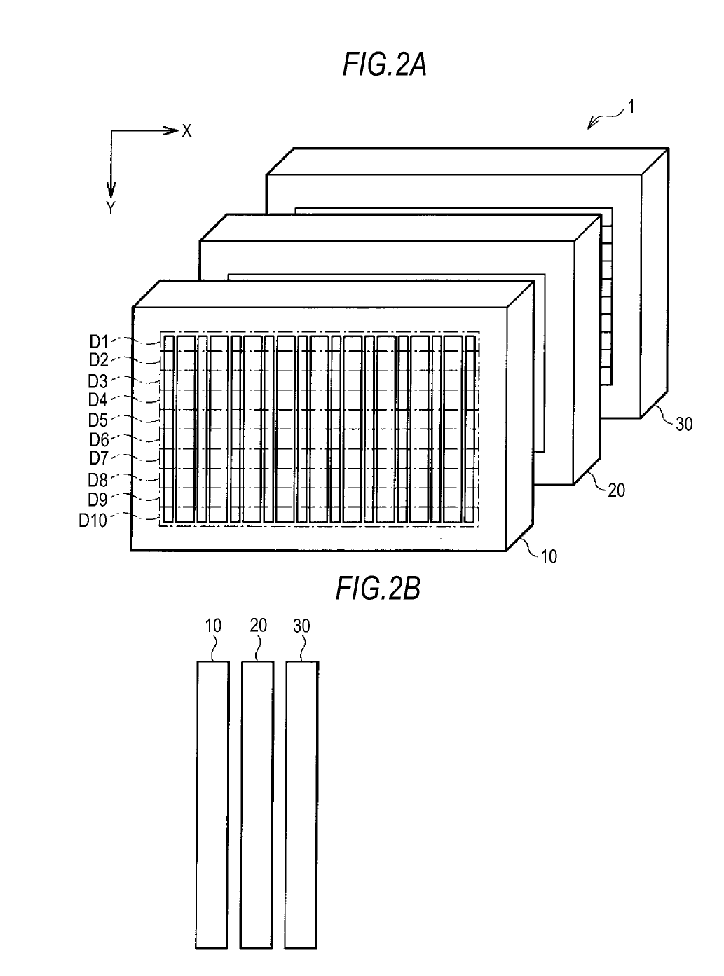

FIGS. 2A and 2B show an example of configuration of a key portion of the stereoscopic display apparatus 1. FIG. 2A is a perspective exploded view showing the configuration of the stereoscopic display apparatus 1, and FIG. 2B is a side view of the stereoscopic display apparatus 1. As shown in FIGS. 2A and 2B, the components of the stereoscopic display apparatus 1 are disposed in the following order: the backlight 30, the display section 20, and the liquid crystal barrier 10. That is, the light emitted from the backlight 30 passes through the display section 20 and the liquid crystal barrier 10 and reaches a viewer. A display surface of the stereoscopic display apparatus 1 is divided into ten display areas D (display areas D1 to D10). The display areas D1 to D10 correspond to the light emitters BL1 to BL10, which will be described later, respectively.

### (Display Driver 50 and Display Section 20)

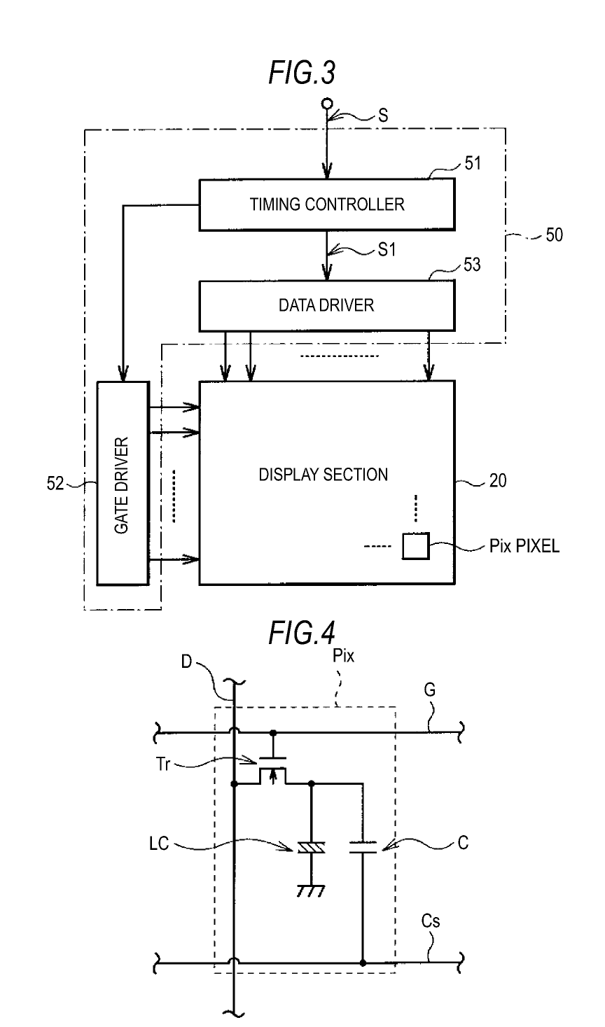

FIG. 3 is an exemplary block diagram of the display driver 50 and the display section 20. The display driver 50 includes a timing controller 51, a gate driver 52, and a data driver 53. The timing controller 51 controls the timings at which the gate driver 52 and the data driver 53 are driven and supplies the data driver 53 with a video image signal S1 based on the video image signal S supplied from the controller 40. The gate driver 52 sequentially selects pixels Pix in the display section 20 on a row basis in accordance with the timing control performed by the timing controller 51 and performs line sequential scanning. The data driver 53 supplies the pixels Pix in the display section 20 with pixel signals based on the video image signal 51. Specifically, the data driver 53 performs D/A (digital/analog) conversion based on the video image signal 51 to produce the pixel signals, which are analog signals, and supplies the pixel signals to the pixels Pix.

The display section 20 is formed by encapsulating a liquid crystal material between two transparent substrates made, for example, of glass. Transparent electrodes made, for example, of ITO (indium tin oxide) are formed on each of the transparent substrates in an area facing the liquid crystal material. The transparent electrodes and the liquid crystal material form the pixels Pix. The pixels Pix are arranged in a matrix in the display section 20, as shown in FIG. 3.

FIG. 4 shows an exemplary circuit diagram of each of the pixels Pix. Each of the pixels Pix includes a TFT (thin film transistor) device Tr, a liquid crystal device LC, and a retention capacitance device C. The TFT device Tr is, for example, a MOS-FET (metal oxide semiconductor-field effect transistor) and has a gate connected to a gate line G, a source connected to a data line D, and a drain connected to an end of the liquid crystal device LC and an end of the retention capacitance device C. The liquid crystal device LC has one end connected to the drain of the TFT device Tr and the other end grounded. The retention capacitance device C has one end connected to the drain of the TFT device Tr and the other end connected to a retention capacitance line Cs. The gate line G is connected to the gate driver 52, and the data line D is connected to the data driver 53.

In the configuration described above, the light emitted from the backlight 30 passes through a polarizer (not shown) disposed on the light-incident side of the display section 20, is converted into light linearly polarized in the direction determined by the polarizer, and is incident on each of the liquid crystal devices LC, where the direction of the liquid crystal molecules changes after a certain response time in accordance with the pixel signal supplied through the data line D. When light is incident on the liquid crystal device LC, the polarization direction of the light changes. The light having passed through the liquid crystal device LC is then incident on a polarizer (not shown) disposed on the light-exiting side of the display section 20, and the polarizer transmits only light having a specific polarization direction. The liquid crystal device LC thus modulates the intensity of the incident light.

### (Backlight Driver 42 and Backlight 30)

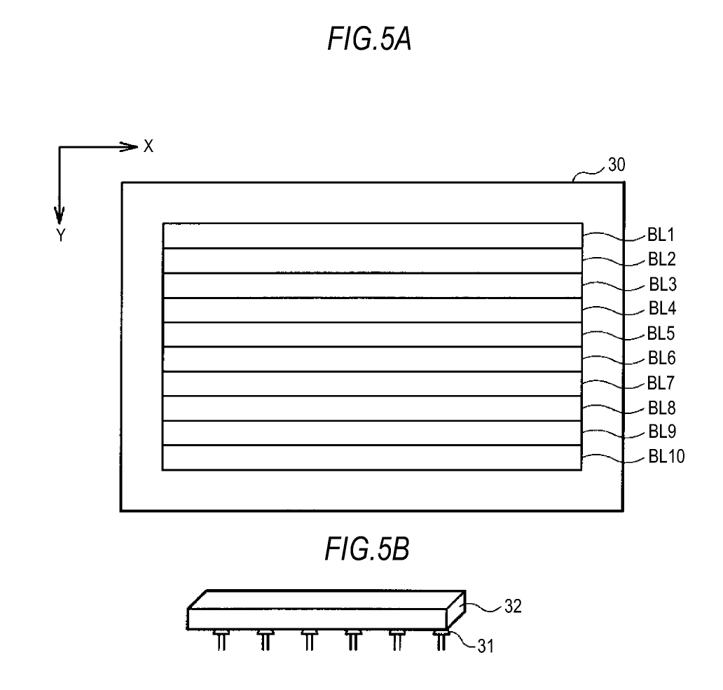

FIGS. 5A and 5B show an example of the configuration of the backlight 30. FIG. 5A is a plan view showing the backlight 30, and FIG. 5B is a perspective view showing a key portion of the backlight 30. In this example, the backlight 30 includes ten light emitters BL1 to BL10, as shown in FIG. 5A, which can emit light independent from one another. The number of light emitters BL is not limited to ten but may be any number greater than one. Each of the light emitters BL includes light sources 31 and a light guide plate 32, as shown in FIG. 5B. Each of the light sources 31 is formed of an LED (light emitting diode) in this example. The light guide plate 32 functions as a diffuser that diffuses the light emitted from the light sources 31 to allow the light emitter BL to emit substantially uniform light in the form of surface emission.

To allow the light emitters BL1 to BL10 to emit light independent from one another, the backlight 30 is so configured that no light leaks from any light emitter BL to the adjacent one. Specifically, light emitted from a light source 31 is incident only on the light guide plate 32 corresponding to the light source 31. The light incident on the light guide plate 32 is totally reflected off the side surfaces of the light guide plate 32, whereby no light leaks through the side surfaces to the light guide plate 32 of the adjacent light emitter BL. The total reflection is achieved specifically by adjusting the position of each of the light sources 31 or forming a reflective layer that reflects light on each of the side surfaces of the light guide plate 32. In this example, each of the light sources 31 is formed of an LED but not limited thereto. Instead, each of the light sources 31 may be formed, for example, of a CCFL (cold cathode fluorescent lamp).

The backlight driver 42 drives the light emitters BL1 to BL10 in such a way that they emit light independent from one another. Specifically, the backlight driver 42 drives the light emitters BL in such a way that the light emitters BL1 to BL10 emit light having different emitted light intensities J at different timings. To allow the light emitters BL to emit light having different emitted light intensities J, it is desirable to control light emission duty ratios of the light emitters BL independent from one another. Alternatively, for example, current conducted for light emission through the light sources 31 in the light emitters may be controlled independent from one another. The backlight driver 42 controls the emitted light intensities J1 to J10 of the light emitters BL1 to BL10 based on the emitted light intensity data 44 held in the emitted light intensity data holder 43.

The light emitters BL1 to BL10 correspond to the display areas D1 to D10 shown in FIG. 2A. That is, for example, the display in the display area D1 is based on the light having exited from the light emitter BL1 and passed through the display section 20 and the liquid crystal barrier 10, whereas the display in the display area D5 is based on the light having exited from the light emitter BL5 and passed through the display section 20 and the liquid crystal barrier 10.

The configuration described above allows the light emitters BL1 to BL10 to emit light at different timings based on drive signals supplied from the backlight driver 42. In the stereoscopic display apparatus 1, the light emitters BL1 to BL10 can therefore sequentially start or stop emitting light in synchronization with the line sequential scanning in the display section 20.

Further, the light emitters BL1 to BL10 can independently emit light having different emitted light intensities J1 to J10 based on the drive signals supplied from the backlight driver 42, whereby the temporally averaged levels of brightness (average brightness levels) in the display areas D1 to D10 can therefore be equal to one another in the stereoscopic display apparatus 1, as will be described later.

### (Liquid Crystal Barrier 10)

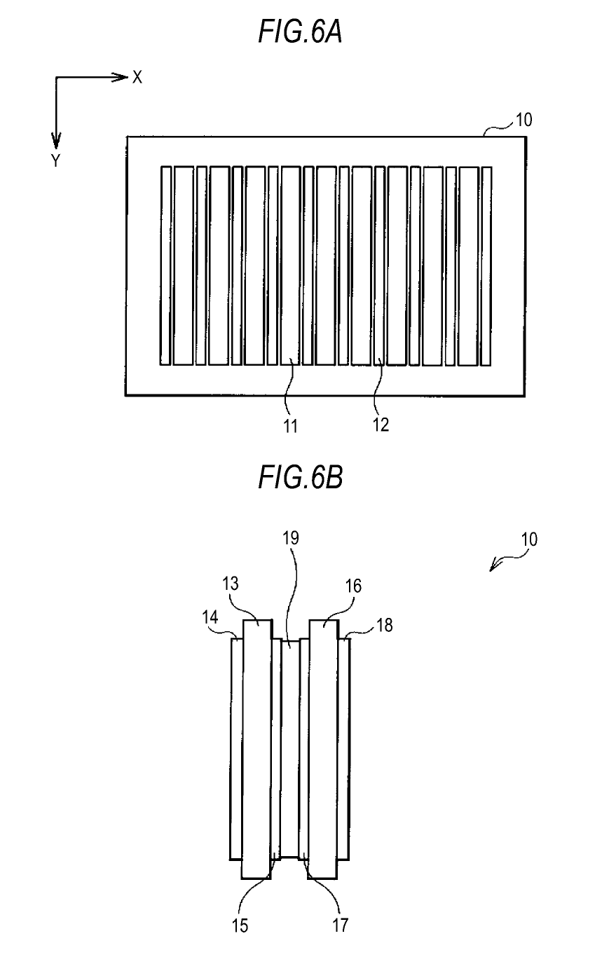

FIGS. 6A and 6B show an example of the configuration of the liquid crystal barrier 10. FIG. 6A is a plan view of the liquid crystal barrier 10, and FIG. 6B is a side view of the liquid crystal barrier 10. In this example, the liquid crystal barrier 10 operates in a normally white scheme. That is, the liquid crystal barrier 10 transmits light when not driven.

The liquid crystal barrier 10 includes a plurality of open/close units 11 and 12 that transmit or block light, as shown in FIG. 6A. The open/close units 11 and 12 are alternately arranged in an x-axis direction and extend in a y-axis direction (sequential scanning direction). The open/close units 11 and 12 operate differently depending on the display mode of the stereoscopic display apparatus 1, a normal display mode (two-dimensional display mode) and a stereoscopic display mode. Specifically, the open/close units 11 are open (transmit light) when the stereoscopic display apparatus 1 operates in the normal display mode, whereas being closed (blocking light) when the stereoscopic display apparatus 1 operates in the stereoscopic display mode, as will be described later. The open/close units 12 are open (transmit light) when the stereoscopic display apparatus 1 operates in the normal display mode, whereas being open or closed in a time division manner when the stereoscopic display apparatus 1 operates in the stereoscopic display mode, as will be described later.

The liquid crystal barrier 10 includes a transparent substrate 13, a transparent substrate 16 facing the transparent substrate 13, and a liquid crystal layer 19 inserted between the transparent substrates 13 and 16, as shown in FIG. 6B. The transparent substrates 13 and 16 are made, for example, of glass. A plurality of transparent electrodes 15 and 17 made, for example, of ITO are formed on the surface of the transparent substrate 13 that faces the liquid crystal layer 19 and the surface of the transparent substrate 16 that faces the liquid crystal layer 19, respectively. The transparent electrodes 15 formed on the transparent substrate 13 and the transparent electrodes 17 formed on the transparent substrate 16 are so disposed that they correspond to each other and form along with the liquid crystal layer 19 the open/close units 11 and 12. A polarizer 14 is formed on the surface of the transparent substrate 13 that faces away from the liquid crystal layer 19, and a polarizer 18 is formed on the surface of the transparent substrate 16 that faces away from the liquid crystal layer 19. Although not shown in FIG. 6B, the display section 20 and the backlight 30 are disposed in the order shown in FIG. 2B to the right of the liquid crystal barrier 10 (to the right of the polarizer 18).

The open/close units 11 and 12 in the liquid crystal barrier 10 are opened or closed in the same manner as the display section 20 displays video images. That is, the light having exited from the backlight 30 and passed through the display section 20 enters the polarizer 18, becomes linearly polarized light having a polarization direction determined by the polarizer 18, and enters the liquid crystal layer 19, where the direction of the liquid crystal molecules changes after a certain response time in accordance with the difference in potential produced between the transparent electrodes 15 and 17. When light is incident on the liquid crystal layer 19, the polarization direction of the light changes. The light having passed through the liquid crystal layer 19 is incident on the polarizer 14, which transmits only light having a specific polarization direction. The liquid crystal layer 19 thus modulates the intensity of the incident light.

In the configuration described above, when a voltage is so applied between the transparent electrode 15 and 17 that the difference in potential therebetween increases, the optical transmittance of the liquid crystal layer 19 decreases and hence the open/close units 11 and 12 block light. On the other hand, when the difference in potential between the transparent electrode 15 and 17 decreases, the optical transmittance of the liquid crystal layer 19 increases and hence the open/close units 11 and 12 transmit light.

In this example, the liquid crystal barrier 10 operates, but does not necessarily, in a normally white scheme. Instead, the liquid crystal barrier 10 may operate, for example, in a normally black scheme. In this case, when the difference in potential between the transparent electrodes 15 and 17 increases, the open/close units 11 and 12 transmit light, whereas when the difference in potential between the transparent electrodes 15 and 17 decreases, the open/close units 11 and 12 block light. Either the normally white scheme or the normally black scheme can be chosen, for example, by changing the settings of the polarizers and the orientation of the liquid crystal molecules.

A plurality of the open/close units 12 form groups, and a plurality of open/close units 12 that belong to the same group are opened or closed at the same timing in the stereoscopic display mode. Grouping of the open/close units 12 will be described below.

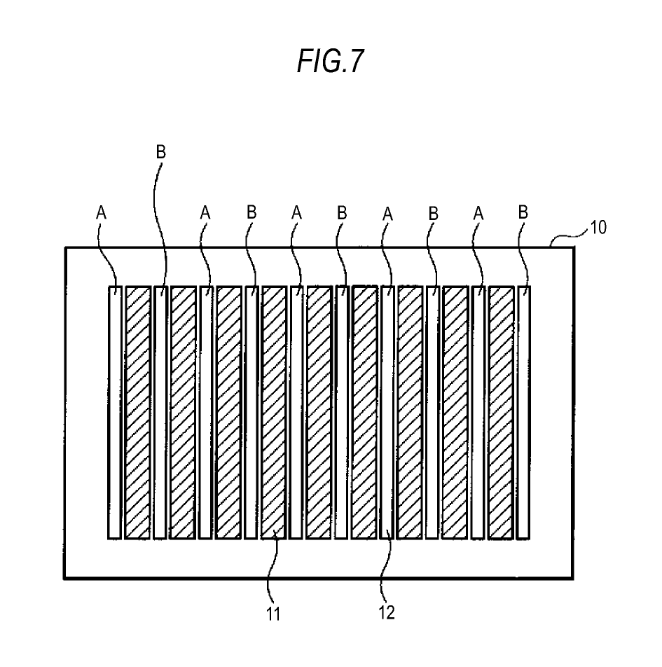

FIG. 7 shows an example of the grouping of the open/close units 12. In this example, the open/close units 12 form two groups. Specifically, a plurality of open/close units 12 that are arranged at every other location form a group A, and the rest of the open/close units 12 that are arranged at every other location form a group B. In the following description, the open/close units 12 that belong to the group A are collectively called open/close units 12A as appropriate. Similarly, the open/close units 12 that belong to the group B are collectively called open/close units 12B as appropriate.

The barrier driver 41 drives the plurality of open/close units 12 that belong to the same group in such a way that they are opened or closed at the same timing in the stereoscopic display mode. Specifically, the barrier driver 41 drives the plurality of open/close units 12A, which belong to the group A, and the plurality of open/close units 12B, which belong to the group B, in such way that they are opened or closed alternately in a time division manner, as will be described later. To operate the plurality of open/close units 12 that belong to the same group at the same timing as described above, the barrier driver 41 may, for example, simultaneously apply drive signals to the transparent electrodes 15 and 17 associated with the plurality of open/close units 12 that belong to the same group. Alternatively, the transparent electrodes 15 and 17 associated with the plurality of open/close units 12 that belong to the same group are connected to each other, and a drive signal may be applied simultaneously thereto.

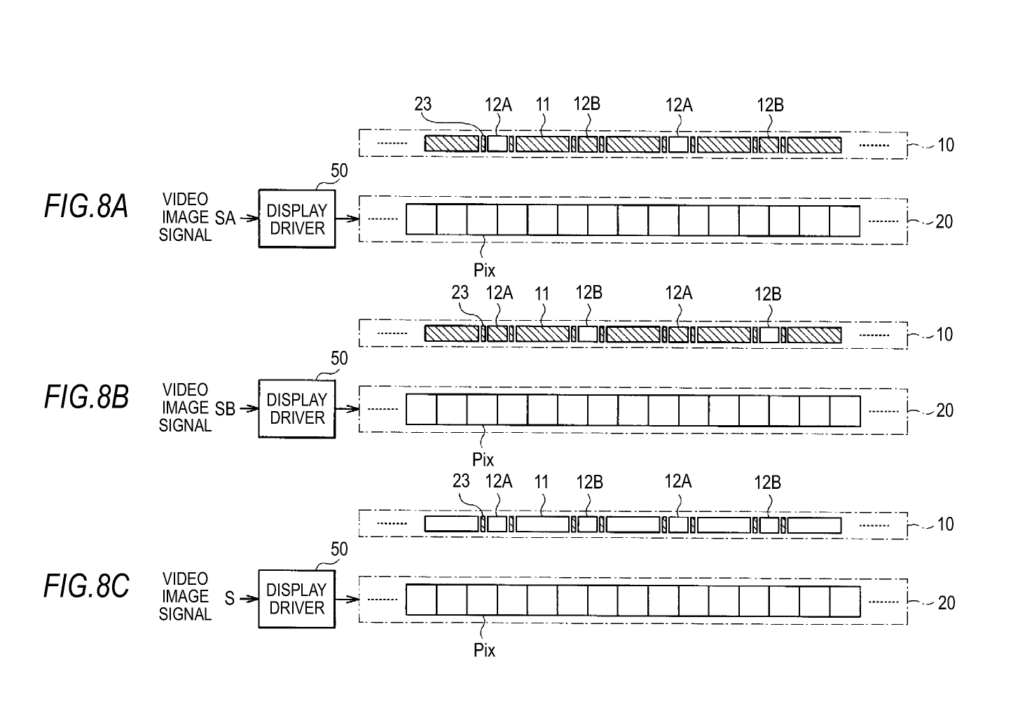

FIGS. 8A to 8C diagrammatically show the state of the liquid crystal barrier 10 in the stereoscopic display mode and the normal display mode (two-dimensional display mode) with reference to the cross-sectional structure of the liquid crystal barrier 10. FIG. 8A shows one state of the liquid crystal barrier 10 in the stereoscopic display mode. FIG. 8B shows the other state of the liquid crystal barrier 10 in the stereoscopic display mode. FIG. 8C shows the state of the liquid crystal barrier 10 in the normal display mode. The open/close units 11 and the open/close units 12 (open/close units 12A and 12B) are alternately arranged in the liquid crystal barrier 10. In this example, the open/close units 12A are provided at a ratio of one open/close unit 12A to six pixels Pix in the display section 20. Similarly, the open/close units 12B are provided at a ratio of one open/close unit 12B to six pixels Pix in the display section 20. In the following description, each of the pixels Pix is formed of, but not necessarily, three sub-pixels (RGB). Alternatively, each pixel Pix may, for example, be a sub-pixel. It is noted in the liquid crystal barrier 10 that the portion where light is blocked is hatched.

In the stereoscopic display mode, the video image signals SA and SB are alternately supplied to the display driver 50, and the display section 20 displays video images based on the video image signals SA and SB. In the liquid crystal barrier 10, the open/close units 12 (open/close units 12A and 12B) are opened or closed in a time division manner, and the open/close units 11 are kept closed (block light). Specifically, when the video image signal SA is supplied, the open/close units 12A are opened, whereas the open/close units 12B are closed, as shown in FIG. 8A. In the display section 20, six pixels Pix disposed adjacent to each other in positions corresponding to each of the open/close units 12A display six viewpoint video images contained in the video image signal SA, as will be described later. In this way, for example, the viewer views the different viewpoint video images with the right and left eyes so that the viewer stereoscopically recognizes the displayed video images, as will be described later. Similarly, when the video image signal SB is supplied, the open/close units 12B are opened, whereas the open/close units 12A are closed, as shown in FIG. 8B. In the display section 20, six pixels Pix disposed adjacent to each other in positions corresponding to each of the open/close units 12B display six viewpoint video images contained in the video image signal SB, as will be described later. In this way, for example the viewer views the different viewpoint video images with the right and left eyes so that the viewer stereoscopically recognizes the displayed video images, as will be described later. In the stereoscopic display apparatus 1, displaying video images by alternately opening the open/close units 12A and the open/close units 12B allows the resolution of the display apparatus to be increased, as will be described later.

In the normal display mode (two-dimensional display mode), the open/close units 11 and the open/close units 12 (open/close units 12A and 12B) in the liquid crystal barrier 10 are both kept open (transmit light), as shown in FIG. 8C. In this way, the viewer can view normal two-dimensional video images displayed in the display section 20 as they are based on the video image signal S.

As shown in FIGS. 8A to 8C, an open/close unit boundary is provided between adjacent open/close unit 11 and open/close unit 12. No transparent electrode 15 or 17 is formed on the transparent substrate 13 or 16 along the open/close unit boundaries 32. That is, the open/close unit boundaries 32 are not opened or closed, unlike the open/close units 11 and 12 but are typically open (transmit light) in the liquid crystal barrier 10 when it operates in the normally white scheme. On the other hand, the open/close unit boundaries 32 are typically closed (block light) in the liquid crystal barrier 10 when it operates in the normally black scheme. Since each of the open/close unit boundaries 32 is much narrower than the open/close units 11 and 12, the viewer seldom notices its presence. In the following drawings and description, the open/close unit boundaries 32 are omitted as appropriate.

The light emitters BL1 to BL10 correspond to a specific example of the “sub-light emitting areas” according to the present disclosure. The open/close units 12 (12A and 12B) correspond to a specific example of the “open/close units” according to the present disclosure. The groups A and B correspond to a specific example of the “open/close unit groups” according to the present disclosure. The liquid crystal barrier 10 corresponds to a specific example of the “light barrier” according to the present disclosure. The backlight driver 42 corresponds to a specific example of the “backlight controller” according to the present disclosure. The emitted light intensity data holder 43 corresponds to a specific example of the “intensity parameter set holder” according to the present disclosure.

### [Operation and Effect]

The operation and effect of the stereoscopic display apparatus 1 of the present embodiment will next be described.

### (Outline of Overall Operation)

The controller 40 supplies control signals to the display driver 50, the backlight driver 42, and the barrier driver 41 based on the externally supplied video image signal Vdisp and controls the drivers to operate in synchronization with one another. The backlight driver 42 drives the light emitters BL in the backlight 30 based on the backlight control signal CBL supplied from the controller 40 and the emitted light intensity data 43 supplied from the emitted light intensity data holder 43. Each of the light emitters BL in the backlight 30 emits light in the form of surface emission toward the display section 20. The display driver 50 drives the display section 20 based on the video image signal S supplied form the controller 40. The display section 20 displays video images by modulating the light emitted from the backlight 30. The barrier driver 41 drives the liquid crystal barrier 10 based on the barrier control signal CBR supplied from the controller 40. The open/close units 11 and 12 (12A and 12B) in the liquid crystal barrier 10 transmit or block the light having exited from the backlight 30 and passed through the display section 20.

### (Detailed Operation in Stereoscopic Display)

Detailed operation in stereoscopic display will next be described with reference to several figures.

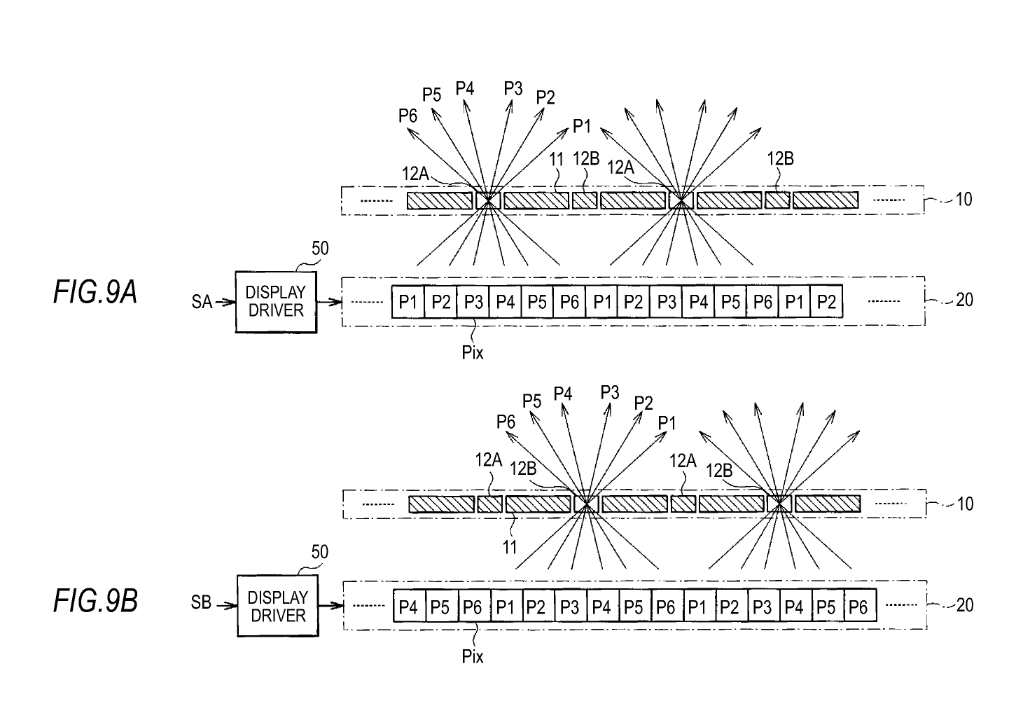

FIGS. 9A and 9B show an example of how the display section 20 and the liquid crystal barrier 10 operate. FIG. 9A shows a case where the video image signal SA is supplied, and FIG. 9B shows a case where the video image signal SB is supplied.

When video image signal SA is supplied, the pixels Pix in the display section 20 display pixel information P1 to P6 corresponding to the six viewpoint video images contained in the video image signal SA, as shown in FIG. 9A. The pieces of pixel information P1 to P6 are displayed through the pixels Pix disposed in the vicinity of each of the open/close units 12A. When the video image signal SA is supplied, the liquid crystal barrier 10 is so controlled that the open/close units 12A are open (transmit light), whereas the open/close units 12B are closed. The light is outputted from each of the pixels Pix in the display section 20 with the angle of the light limited by the corresponding open/close unit 12A. The viewer for example, views the pixel information P3 with the left eye and the pixel information P4 with the right eye for stereoscopic recognition of the video images.

When video image signal SB is supplied, the pixels Pix in the display section 20 displays the pixel information P1 to P6 corresponding to the six viewpoint video images contained in the video image signal SB, as shown in FIG. 9B. The pieces of pixel information P1 to P6 are displayed through the pixels Pix disposed in the vicinity of each of the open/close units 12B. When the video image signal SB is supplied, the liquid crystal barrier 10 is so controlled that the open/close units 12B are open (transmit light), whereas the open/close units 12A are closed. The light is outputted from each of the pixels Pix in the display section 20 with the angle of the light limited by the corresponding open/close unit 12B. The viewer, for example, views the pixel information P3 with the left eye and the pixel information P4 with the right eye for stereoscopic recognition of the video images.

As described above, the viewer views different portions of the pixel information P1 to P6 with the right and left eyes for stereoscopic recognition of the video images. Further, displaying video images by alternately opening the open/close units 12A and the open/close units 12B in a time division manner allows the viewer to average the video images displayed in positions shifted from each other. The stereoscopic display apparatus 1 can therefore achieve resolution twice higher than that achieved when only the open/close units 12A are provided. In other words, the resolution of the stereoscopic display apparatus 1 is only reduced to one-third (=1/6×2) the resolution achieved in the two-dimensional display.

The operation of the liquid crystal barrier 10, the display section 20, and the backlight 30 will next be described in detail.

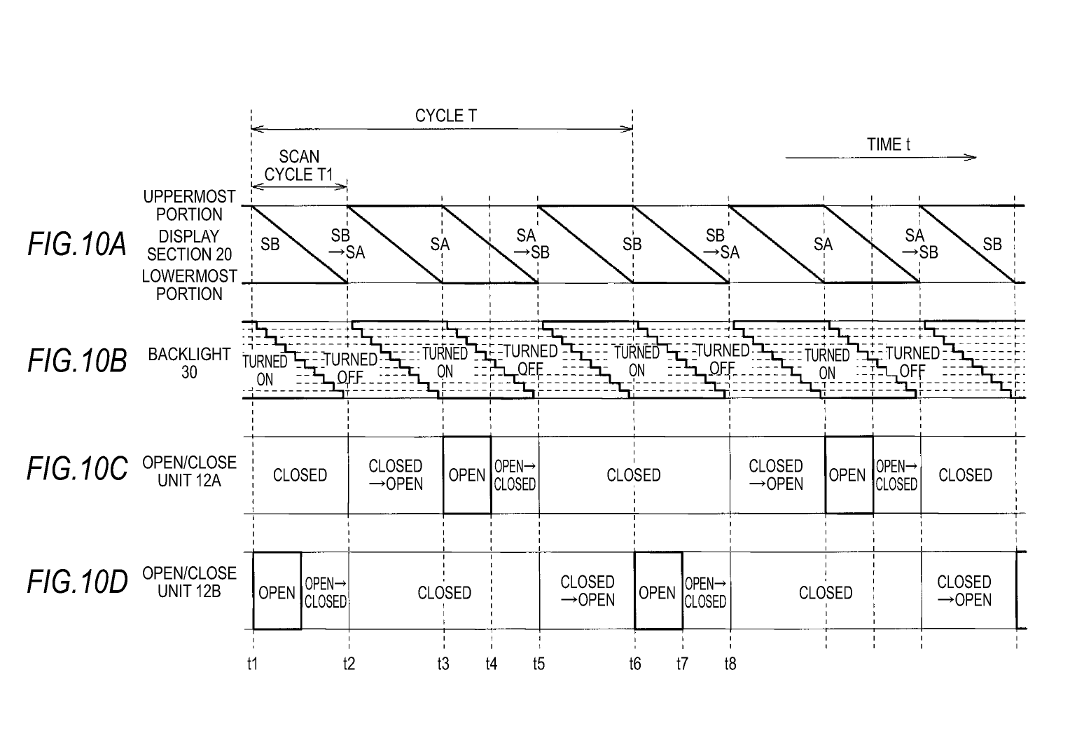

FIGS. 10A to 10D are timing charts showing how the stereoscopic display apparatus 1 displays video images. FIG. 10A shows how the display section 20 operates. FIG. 10B shows how the backlight 30 operates. FIG. 10C shows how the open/close units 12A in the liquid crystal barrier 10 operate. FIG. 10D shows how the open/close units 12B in the liquid crystal barrier 10 operate. The vertical axes of FIGS. 10A and 10B represent the position in the line sequential scanning direction (y-axis direction) in the display section 20 and the backlight 30. That is, FIG. 10A shows the operation of the display section 20 in a certain position in the y-axis direction at a certain point of time. Similarly, FIG. 10B shows the operation of the backlight 30 in a certain position in the y-axis direction at a certain point of time.

In FIG. 10A, “SA” represents a state in which the display section 20 displays video images based on the video image signal SA, and “SB” represents a state in which the display section 20 displays video images based on the video image signal SB. Further, “SA→SB” represents a state in which the display driver 50 is supplied with the video image signal SB and the display section 20 changes the display based on the video image signal SA to the display based on the video image signal SB. Similarly, “SB→SA” represents a state in which the display driver 50 is supplied with the video image signal SA and the display section 20 changes the display based on the video image signal SB to the display based on the video image signal SA. The symbols “SA→SB” and “SB→SA” correspond to responses of the liquid crystal molecules in the display section 20.

In FIGS. 10C and 10D, “open” represents that the open/close units 12 are open, and “closed” represents that the open/close units 12 are closed. Further, “open→closed” represents that the state of the open/close units 12 is changed from the open state to the closed state, and “closed→open” represents that the state of the open/close units 12 is changed from the closed state to the open state. The symbols “open→closed” and “closed→open” correspond to responses of the liquid crystal molecules in the open/close units 12 in the liquid crystal barrier 10.

The stereoscopic display apparatus 1 performs the line sequential scanning at a scan cycle T1 to alternately display video images through the open/close units 12A (based on video image signal SA) and video images through the open/close units 12B (based on video image signal SB) in a time division manner. A set of the two types of display is repeated at a cycle T. The cycle T can, for example, be set at 16.7 [msec] (one cycle of 60 [Hz]). In this case, the scan cycle T1 is 4.2 [msec] (one-fourth the cycle T).

First, from a timing t1 to a timing t2, the display section 20 performs line sequential scanning from the uppermost portion toward the lowermost portion of the display section 20 based on the drive signal supplied from the display driver 50, and the display based on the video image signal SB is changed to the display based on the video image signal SA (FIG. 10A). In the backlight 30, the light emitters BL1 to BL10 are sequentially turned off based on the drive signals supplied from the backlight driver 42 in synchronization with the line sequential scanning in the display section 20 (FIG. 10B). The viewer will therefore not see the change in the display section 20 (“SB→SA”), whereby degradation in image quality can be reduced.

Thereafter, from the timing t2 to a timing t3, the display section 20 performs line sequential scanning from the uppermost portion toward the lowermost portion of the display section 20 based on the drive signal supplied from the display driver 50 and displays video images based on the video image signal SA (FIG. 10A). That is, in this example, the display operation based on the same video image signal SA is repeated twice in the period from the timing t1 to the timing t3. In the backlight 30, the light emitters BL1 to BL10 are sequentially turned on based on the drive signals supplied from the backlight driver 42 in synchronization with the line sequential scanning in the display section 20 (FIG. 10B). At this point, the light emitters BL1 to BL10 emit light having emitted light intensities based on the emitted light intensity data 44. In the liquid crystal barrier 10, the state of the open/close units 12A is changed from the closed state to the open state based on the drive signal from the barrier driver 41 (FIG. 10C).

Thereafter, from the timing t3 to a timing t5, the display section 20 performs line sequential scanning based on the drive signal supplied from the display driver 50, and the display based on the video image signal SA is changed to the display based on the video image signal SB (FIG. 10A). In the backlight 30, the light emitters BL1 to BL10 are sequentially turned off based on the drive signal supplied from the backlight driver 42 in synchronization with the line sequential scanning in the display section 20 (FIG. 10B). In the liquid crystal barrier 10, the open/close units 12A are kept open from the timing t3 to a timing t4, and the state of the open/close units 12A is changed from the open state to the closed state in the period from the timing t4 to the timing t5 based on the drive signal from the barrier driver 41 (FIG. 10C). In this way, from the timing t3 to the timing t4, the viewer can look at the display based on the video image signal SA in the display section 20 only for the turned-on light emitters BL in the backlight 30. It is noted in the above description that the viewer can look at video images displayed in the display section 20 from the timing t3 to the timing t4, during which the open/close units 12A are open, for the convenience of description. In practice, however, the video images become gradually visible when the state of the open/close units 12A is changed from the closed state to the open state, whereas becoming gradually invisible when the state of the open/close units 12A is changed from the open state to the closed state.

Thereafter, from the timing t5 to a timing t6, the display section 20 performs line sequential scanning and displays video images based on the video image signal SB (FIG. 10A). In the backlight 30, the light emitters BL1 to BL10 are sequentially turned on and start emitting light having emitted light intensities based on the emitted light intensity data 44 based on the drive signals supplied from the backlight driver 42 in synchronization with the line sequential scanning in the display section 20 (FIG. 10B). In the liquid crystal barrier 10, the state of the open/close units 12B is changed from the closed state to the open state based on the drive signal from the barrier driver 41 (FIG. 10D).

Thereafter, from the timing t6 to a timing t8, the display section 20 performs line sequential scanning, and the display based on the video image signal SB is changed to the display based on the video image signal SA (FIG. 10A). In the backlight 30, the light emitters BL1 to BL10 are sequentially turned off based on the drive signals supplied from the backlight driver 42 in synchronization with the line sequential scanning in the display section 20 (FIG. 10B). In the liquid crystal barrier 10, the open/close units 12B are kept open from the timing t6 to a timing t7, and the state of the open/close units 12B is changed from the open state to the closed state in the period from the timing t7 to the timing t8 based on the drive signal from the barrier driver 41 (FIG. 10D). In this way, from the timing t6 to the timing t7, the viewer can look at the display based on the video image signal SB in the display section 20 only for the turned-on light emitters BL in the backlight 30.

The stereoscopic display apparatus 1 repeats the operation described above to alternately display video images through the open/close units 12A (based on video image signal SA) and video images through the open/close units 12B (based on video image signal SB).

In the stereoscopic display apparatus 1, the light emitters BL1 to BL10, when turned on, emit light having emitted light intensities based on the emitted light intensity data 44. The light emission will be described in detail with reference to video images (based on video image signal SA) displayed through the open/close units 12A.

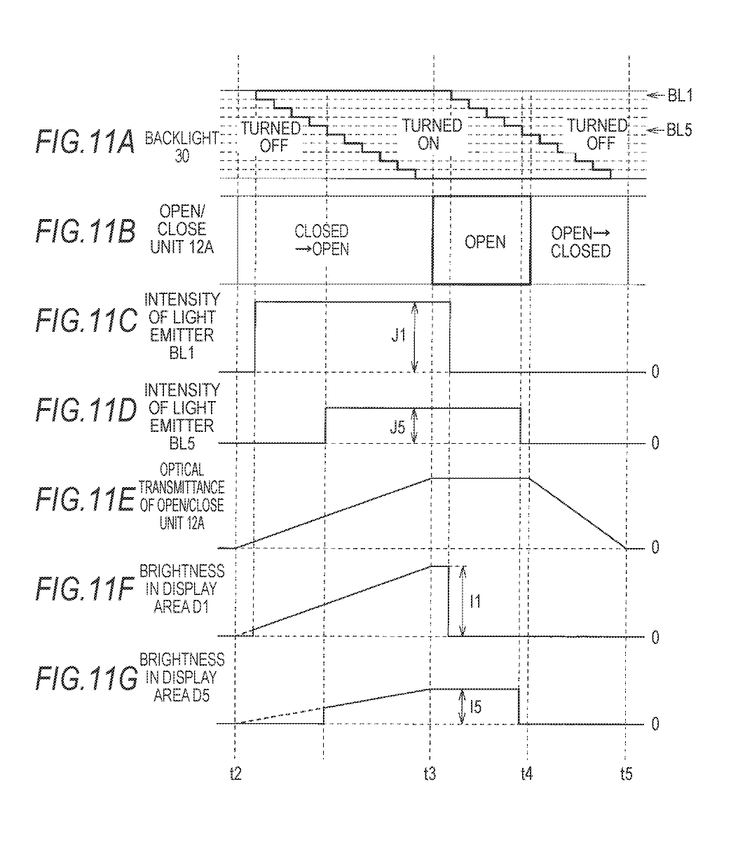

FIGS. 11A to 11G show how the stereoscopic display apparatus 1 operates at the time of white display. FIG. 11A shows how the entire backlight 30 operates. FIG. 11B shows how the open/close units 12A operate. FIG. 11C shows the emitted light intensity of the light emitter BL1. FIG. 11D shows the emitted light intensity of the light emitter BL5. FIG. 11E shows optical transmittance of the open/close units 12A. FIG. 11F shows the brightness in the display area D1. FIG. 11G shows the brightness in the display area D5. FIGS. 11A to 11G correspond to the operation in the period from the timing t2 to the timing t5 shown in FIGS. 10A to 10D. Further, the brightness in the display area D1 (FIG. 11F) corresponds to the intensity of the light having exited from the light emitter BL1 and passed through the display section 20 in a white display state and the corresponding open/close unit 12A in the liquid crystal barrier 10 or corresponds to the product of the intensity of the light emitter BL1 (FIG. 11C) and the optical transmittance of the corresponding open/close unit 11A (FIG. 11E). Similarly, the brightness in the display area D5 (FIG. 11G) corresponds to the intensity of the light having exited from the light emitter BL5 and passed through the display section 20 in the white display state and the corresponding open/close unit 12A in the liquid crystal barrier 10 or corresponds to the product of the intensity of the light emitter BL5 (FIG. 11D) and the optical transmittance of the corresponding open/close unit 11A (FIG. 11E). In the following description, the optical transmittance is assumed to change linearly during the transition between the open state and the closed state of the open/close units 12A (“open→closed”, “closed→open”) for ease of description as shown in FIG. 11E.

From the timing t2 to the timing t3, when the state of the open/close units 12A is changed from the closed state to the open state (FIG. 11B), the optical transmittance of the open/close units 12A also changes (FIG. 11E), and the brightness in the display areas D1 and D5 (FIGS. 11F and 11G) changes in accordance with the states of the light emitters BL in the backlight 30 (FIGS. 11C and 11D). Specifically, the brightness in the display area D1 gradually increases (FIG. 11F) while the light emitter BL1 emits light (FIG. 11C) in accordance with the open/close state of the corresponding open/close unit 12A. Similarly, the brightness in the display area D5 gradually increases (FIG. 11G) while the light emitter BL5 emits light (FIG. 11D) in accordance with the open/close state of the corresponding open/close unit 12A.

Thereafter, from the timing t3 to the timing t4, when the open/close units 12A are open, the brightness levels in the display areas D1 and D5 become fixed (brightness levels I1 and I5). The brightness I1 corresponds to the emitted light intensity J1 of the light having exited from the light emitter BL1 but passed through the display section 20 and the corresponding open/close unit 12A, and the brightness 15 corresponds to the emitted light intensity J5 of the light having exited from the light emitter BL5 but passed through the display section 20 and the corresponding open/close unit 12A. When the light emitter BL1 in the backlight 30 is turned off (FIG. 11C), the brightness in the display area D1 decreases accordingly (FIG. 11F), and when the light emitter BL5 is turned off (FIG. 11D), the brightness in the display area D5 decreases accordingly (FIG. 11G).

Thereafter, from the timing t4 to the timing t5, when the state of the open/close units 12A is changed from the open state to the closed state (FIG. 11B), the optical transmittance of the open/close units 12A decreases to zero (FIG. 11E).

As shown in FIGS. 11A to 11G, since the temporal relationship between the period during which a light emitter BL in the backlight 30 emits light and the period during which the corresponding open/close unit 12 is open (open period) differs from the temporal relationship between another light emitter BL and the corresponding open/close unit 12, the averages of the brightness levels in the display areas D (average brightness levels) differ from one another if the light emitters BL emit light having the same emitted light intensity. To address the problem, in the stereoscopic display apparatus 1, the emitted light intensities J of the light emitters BL are set independent from one another in such a way that the display areas D have the same average brightness. Specifically, for example, setting the emitted light intensity J1 of the light emitter BL1 to be higher than the emitted light intensity J5 of the light emitter BL5 allows the brightness I1 to be higher than the brightness 15, as shown in FIGS. 11A to 11G, whereby the temporal average brightness in the display area D1 (FIG. 11F) and the temporal average brightness in the display area D5 (FIG. 11G) are equal to each other.

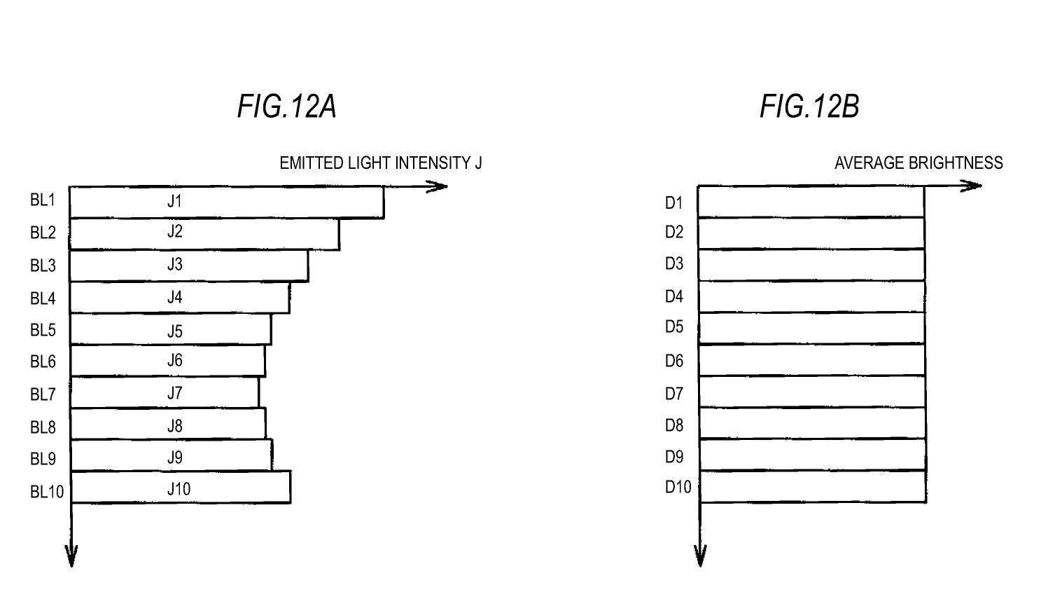

FIGS. 12A and 12B show the relationship between the intensities and the brightness levels in the stereoscopic display apparatus 1 at the time of white display. FIG. 12A shows emitted light intensities J1 to J10 of the light emitters BL1 to BL10, and FIG. 12B shows average brightness levels in the display areas D1 to D10. The backlight driver 42 sets the emitted light intensities J1 to J10 of the light emitters BL1 to BL10 in the backlight 30 based on the emitted light intensity data 44 held in the emitted light intensity data holder 43, for example, as shown in FIG. 12A. As a result, the average brightness levels in the display areas D1 to D10 at the time of white display can be substantially uniform, as shown in FIG. 12B. The average brightness levels in the display areas D1 to D10 are made equal to each other in this example but are not necessarily made equal to each other. The average brightness levels may slightly differ from each other to the extent that the viewer recognizes no degradation in image quality.

### Comparative Example

A stereoscopic display apparatus 1R according to Comparative Example will next be described. In the Comparative Example, the emitted light intensities J1 to J10 of the light emitters BL1 to BL10 are equal to one another. The other configurations are the same as those in the present embodiment (FIG. 1).

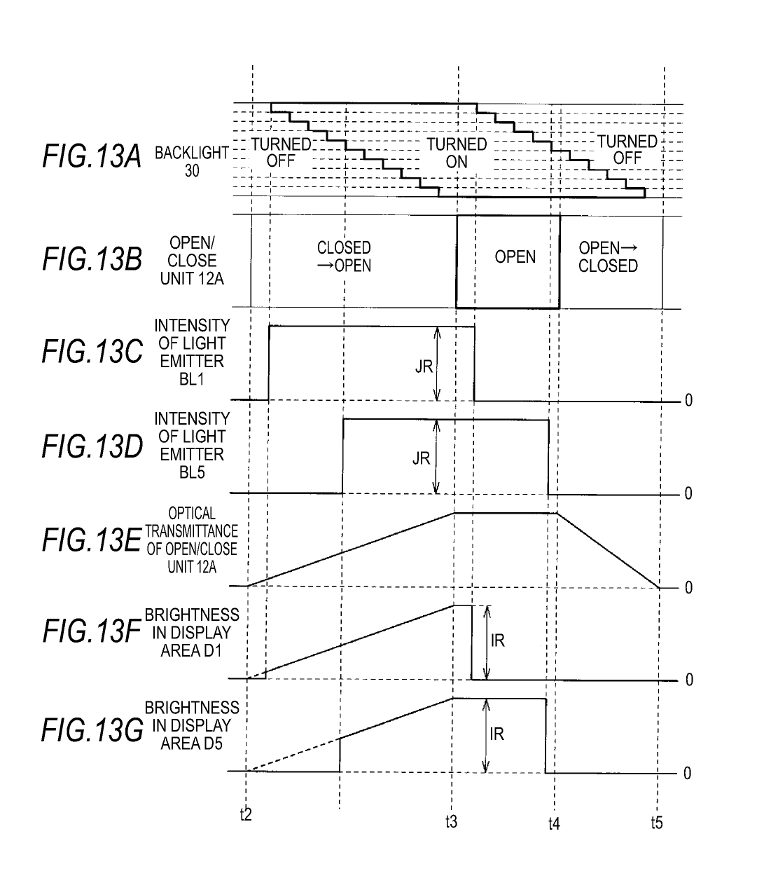

FIGS. 13A to 13G show how the stereoscopic display apparatus 1R operates at the time of white display. FIG. 13A shows how the entire backlight 30 operates. FIG. 13B shows how the open/close units 12A operate. FIG. 13C shows the emitted light intensity of the light emitter BL1. FIG. 13D shows the emitted light intensity of the light emitter BL5. FIG. 13E shows optical transmittance of the open/close units 12A. FIG. 13F shows the brightness in the display area D1. FIG. 13G shows the brightness in the display area D5.

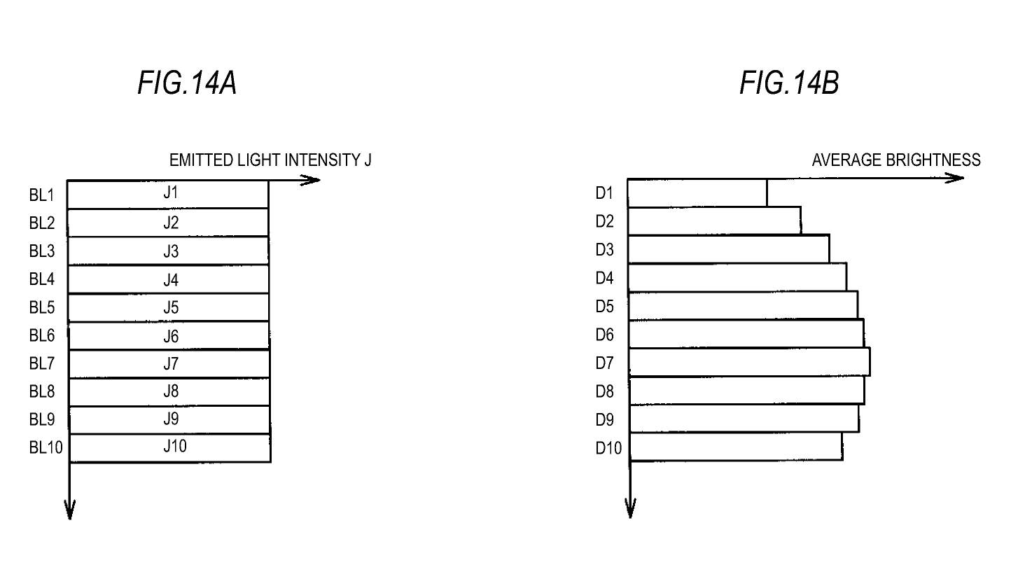

FIGS. 14A and 14B show the relationship between the intensities and the brightness levels in the stereoscopic display apparatus 1R at the time of white display. FIG. 14A shows the emitted light intensities J1 to J10 of the light emitters BL1 to BL10, and FIG. 14B shows average brightness levels in the display areas D1 to D10.

As shown in FIGS. 13A to 13G, in the stereoscopic display apparatus 1R, the light emitters BL1 to BL10 emit light having the same emitted light intensity JR (FIGS. 13C and 13D), whereby when the open/close units 12A are open, the brightness levels in the display areas D1 and D5 are equal to each other (brightness IR). However, since the temporal relationship between the period during which a light emitter BL in the backlight 30 emits light and the period during which the corresponding open/close unit 12 is open (open period) differs from the temporal relationship between another light emitter BL and the corresponding open/close unit 12, the averages of the brightness levels in the display areas D (average brightness levels) differ from one another, as shown in FIG. 14B.

On the other hand, in the stereoscopic display apparatus 1 according to the present embodiment, the light emitters BL1 to BL10 can independently emit light having different emitted light intensities J1 to J10, whereby the averages of the brightness levels in the display areas D (average brightness levels) can be equal to one another as shown in FIG. 12B.

### ADVANTAGEOUS EFFECT

In the present embodiment described above, since the backlight is divided into a plurality of light emitters, and the emitted light intensities of the light emitters can be set independent from one another, the average brightness levels in the display areas across the display surface can be adjusted independent from one another.

Further, in the present embodiment, since the emitted light intensity of each of the light emitters in the backlight is set based on the temporal relationship between the period during which the light emitter emits light and the period during which the corresponding open/close unit is open, the average brightness levels in the display areas across the display surface can be equal to one another, whereby the brightness can be uniform across the display surface.

### [Variation 1]

In the embodiment described above, the emitted light intensity data holder 43 is provided and the emitted light intensities J of the light emitters BL are set based on the emitted light intensity data 44 held in the emitted light intensity data holder 43 but the stereoscopic display apparatus is not necessarily configured this way. Instead, for example, the emitted light intensity data holder 43 may not be provided, but the emitted light intensities J of the light emitters BL may be set based on the number of light sources 31 in each of the light emitters BL in the backlight 30.

### 2. Second Embodiment

A stereoscopic display apparatus 2 according to a second embodiment of the present disclosure will next be described. In the present embodiment, a temperature sensor is provided, and the settings of the emitted light intensities J of the light emitters BL1 to BL10 are changed based on the temperature. The components that are substantially the same as those in the stereoscopic display apparatus 1 according to the first embodiment described above have the same reference characters, and no description of these components will be made as appropriate.

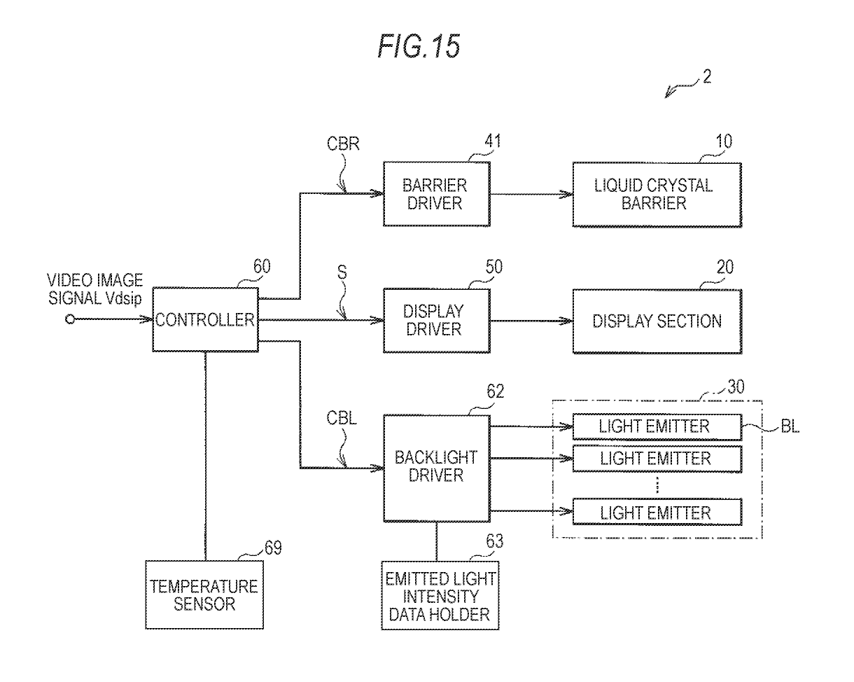

FIG. 15 shows an example of the configuration of the stereoscopic display apparatus 2. The stereoscopic display apparatus 2 includes a temperature sensor 69, a controller 60, an emitted light intensity data holder 63, and a backlight driver 62. The temperature sensor 69 detects temperature. The controller 60 not only controls the display driver 50 and the barrier driver 41 but also controls the backlight driver based on temperature information supplied from the temperature sensor 69. The emitted light intensity data holder 63 has an LUT (look up table) 64 containing a plurality of sets of emitted light intensity data 44. The plurality of sets of emitted light intensity data 44 are used to instruct the light emitters BL to set emitted light intensities J (emitted light intensities J1 to J10, which will be described later) within a plurality of temperature ranges each of which has, for example, a range of 10° C. The backlight driver 62 has a function of selecting from the LUT 64 emitted light intensity data 44 corresponding to the temperature information supplied from the controller 60 and controlling the backlight 30 based on the thus selected emitted light intensity data 44.

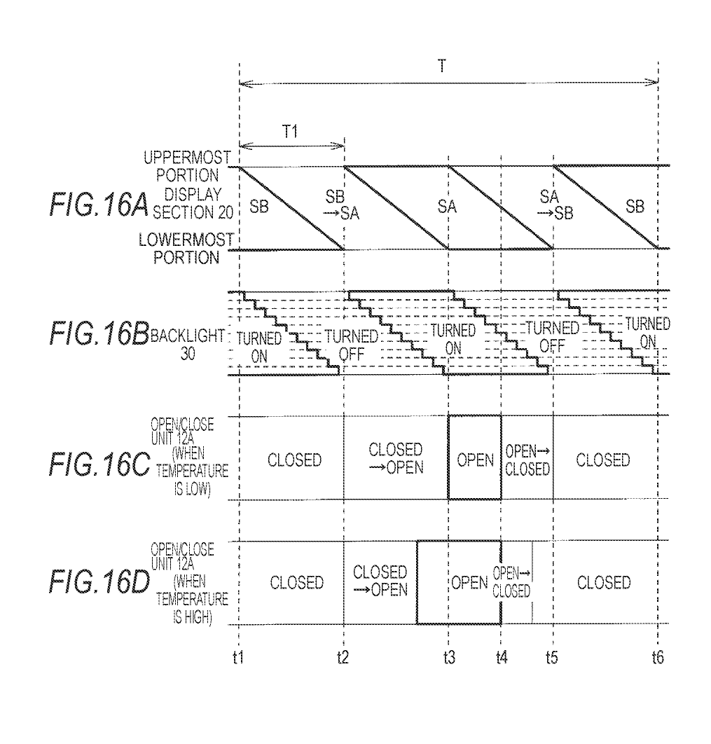

FIGS. 16A to 16D are timing charts showing how the stereoscopic display apparatus 2 displays video images. FIG. 16A shows how the display section 20 operates. FIG. 16B shows how the backlight 30 operates. FIG. 16C shows how the open/close units 12A operate when the temperature is low. FIG. 16D shows how the open/close units 12A operate when the temperature is high. FIGS. 16A to 16D correspond to the operation in the period from the timing t1 to the timing t6 shown in FIGS. 10A to 10D.

The response time of liquid crystal molecules typically changes with temperature. When the temperature is low, the response time lengthens, whereas when the temperature is high, the response time shortens. In view of the fact described above, in the liquid crystal barrier 10, the period necessary for the open/close units 12 (12A and 12B) to change their states from the open state to the closed state and the period necessary to change the states from the closed state to the open state lengthen when the temperature is low (FIG. 16C), whereas the periods described above shorten when the temperature is high (FIG. 16D). As a result, since the temporal relationship between the period during which the backlight 30 emits light and the period during which the open/close units 12 are open changes with temperature, it is necessary to change the emitted light intensities J of the light emitters BL in accordance with the temperature in order to make the average brightness levels in the display areas D across the display surface equal to one another.

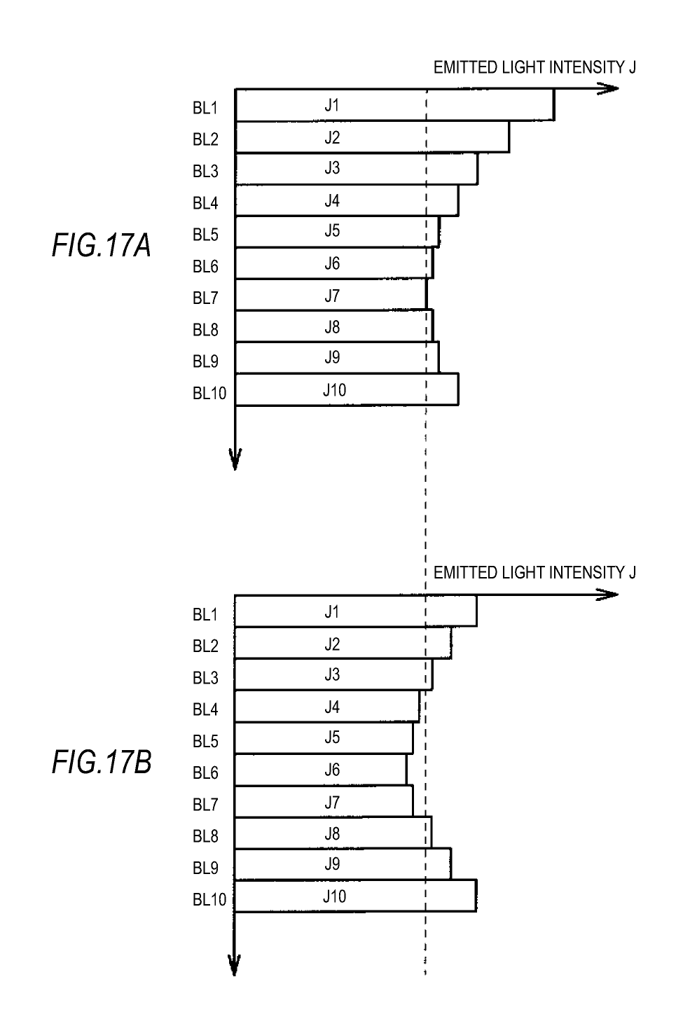

FIGS. 17A and 17B show the emitted light intensities J of the light emitters BL. FIG. 17A shows the emitted light intensities J when the temperature is low, and FIG. 17B shows the emitted light intensities J when the temperature is high. The emitted light intensities J (J1 to J10) are so set that the average brightness levels in the display areas D1 to D10 are equal to one another when the temperature is both low and high. Further, since the period during which the open/close units 12A are open when the temperature is high is longer than that when the temperature is low as shown in FIGS. 16C and 16D, the emitted light intensities J are set to be low as a whole when the temperature is high, as shown in FIGS. 17A and 17B. The brightness across the display surface will therefore not greatly change even when the temperature changes.

As described above, in the present embodiment, since the emitted light intensity of each of the light emitters in the backlight is set within each temperature range based on the temporal relationship between the period during which the light emitter emits light and the period during which the corresponding open/close unit are open, the average brightness levels in the display areas across the display surface can be equal to one another even when the temperature changes, whereby the brightness can be uniform across the display surface.

Further, in the present embodiment, since when the temperature is high, the emitted light intensities of the light emitters are set to be lower than those when the temperature is low, the brightness across the display surface will not greatly change even when the temperature changes.

Other advantageous effects are the same as those in the first embodiment described above.

### 3. Third Embodiment

A stereoscopic display apparatus 3 according to a third embodiment of the present disclosure will next be described. In the present embodiment, the timings at which the open/close units 12 in the liquid crystal barrier are opened or closed are changed with temperature, and the settings of the emitted light intensities J of the light emitters BL1 to BL10 in the backlight 30 are also changed with temperature. The components that are substantially the same as those in the stereoscopic display apparatus 1 and 2 according to the first and second embodiments described above have the same reference characters, and no description of these components will be made as appropriate.

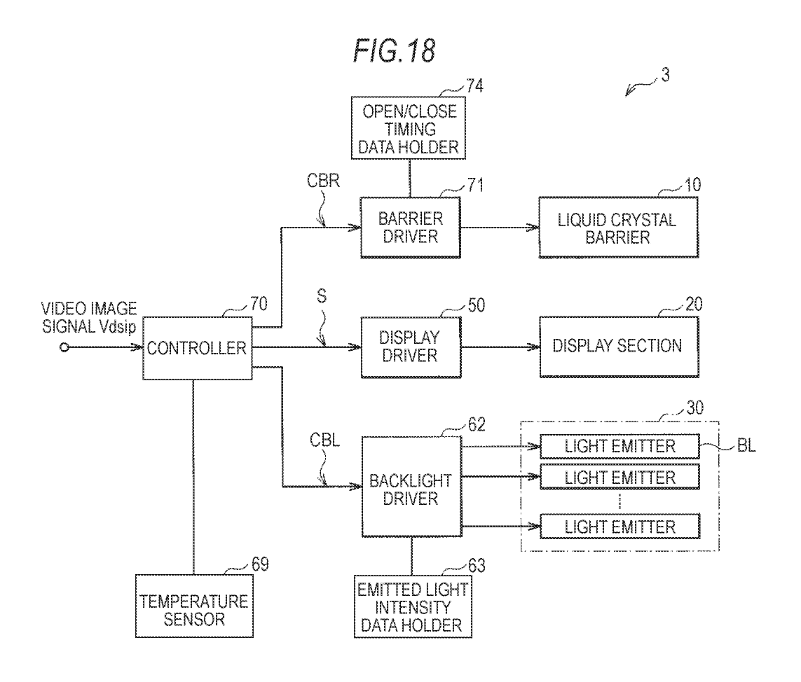

FIG. 18 shows an example of the configuration of the stereoscopic display apparatus 3. The stereoscopic display apparatus 3 includes the temperature sensor 69, a controller 70, an open/close timing data holder 74, and a barrier driver 71. The controller 70 not only controls the display driver 50 but also controls the barrier driver 71 and the backlight driver 62 based on temperature information supplied from the temperature sensor 69. The open/close timing data holder 74 has an LUT 76 containing a plurality of sets of open/close timing data 75 representing the timings at which the open/close units 12 (12A and 12B) in the liquid crystal barrier 10 are opened or closed. The plurality of sets of open/close timing data 75 are used to instruct the liquid crystal barrier 10 to set the timings at which the open/close units 12 are opened or closed within a plurality of temperature ranges. The barrier driver 71 has a function of selecting from the LUT 76 open/close timing data 75 corresponding to the temperature information supplied from the controller 70 and controlling the liquid crystal barrier 10 based on the selected open/close timing data 75.

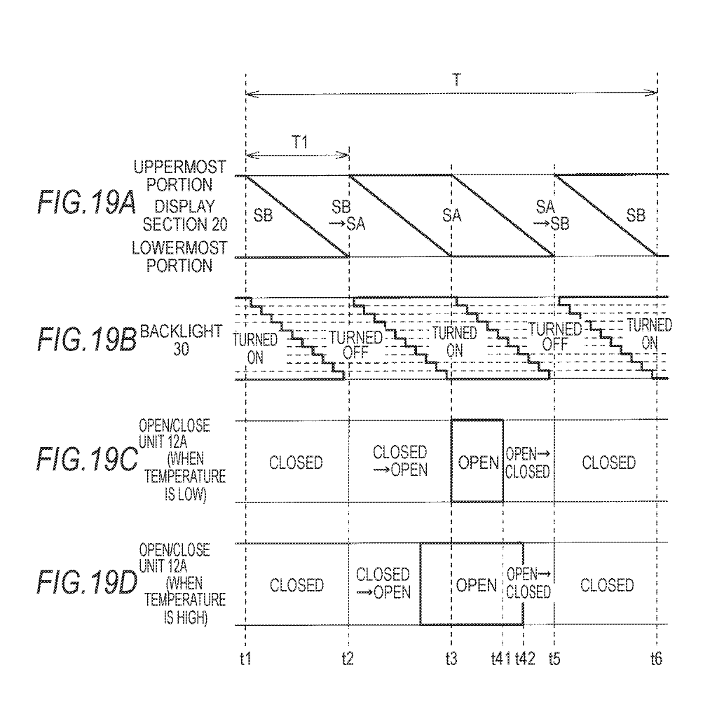

FIGS. 19A to 19D are timing charts showing how the stereoscopic display apparatus 3 displays video images. FIG. 19A shows how the display section 20 operates. FIG. 19B shows how the backlight 30 operates. FIG. 19C shows how the open/close units 12A operate when the temperature is low. FIG. 19D shows how the open/close units 12A operate when the temperature is high. FIGS. 19A to 19D correspond to the operation in the period from the timing t1 to the timing t6 shown in FIGS. 10A to 10D.

The stereoscopic display apparatus 3 is so controlled that when the response time of the liquid crystal molecules changes with temperature, the timings at which the open/close units 12 (12A and 12B) complete changing their states from the open state to the closed state coincide with the timing t5 when the scanning in the display section 20 ends. That is, when the temperature is low, the barrier driver 71 controls the open/close units 12A in such a way that they start changing their states from the open state to the closed state at a timing t41, whereby the open/close units 12A are closed at the timing t5 after the response time thereof elapses, as shown in FIG. 19C. Similarly, when the temperature is high, the barrier driver 71 controls the open/close units 12A in such a way that they start changing their states from the open state to the closed state at a timing t42, whereby the open/close units 12A are closed at the timing t5 after the response time thereof elapses, as shown in FIG. 19D. The control described above allows the period during which the open/close units 12A are open (open period) to lengthen, whereby the brightness across the display surface can be increased.

When the timing at which the open/close units 12A are opened or closed is controlled as described above, the temporal relationship between the period during which the backlight 30 emits light and the period during which the open/close units 12A are open still changes with temperature. Changing the emitted light intensities J of the light emitters BL with temperature allows the average brightness levels in the display areas D across the display surface to be equal to one another, as in the case of the stereoscopic display apparatus 2 according to the second embodiment described above.

As described above, in the present embodiment, in which the timing at which each of the open/close units starts changing its state from the open state to the closed state is changed with temperature, the timing at which the open state is completely changed to the closed state coincides with the timing at which the line sequential scanning in the display section ends, whereby the period during which the open/close unit is open can be lengthened and the brightness across the display surface can be increased accordingly.

Other advantageous effects are the same as those in the first and second embodiments described above.

### 4. Fourth Embodiment

A stereoscopic display apparatus 4 according to a fourth embodiment of the present disclosure will next be described. In the present embodiment, the open/close units 12 in the liquid crystal barrier 10 in the first embodiment described above are divided in the line sequential scanning direction (y-axis direction). That is, in the present embodiment, the stereoscopic display apparatus 4 includes a liquid crystal barrier 80 obtained by dividing the open/close units 12 instead of the liquid crystal barrier 10 in the first embodiment described above (FIGS. 1, 2A, and 2B). The components that are substantially the same as those in the stereoscopic display apparatus 1 according to the first embodiment described above have the same reference characters, and no description of these components will be made as appropriate.

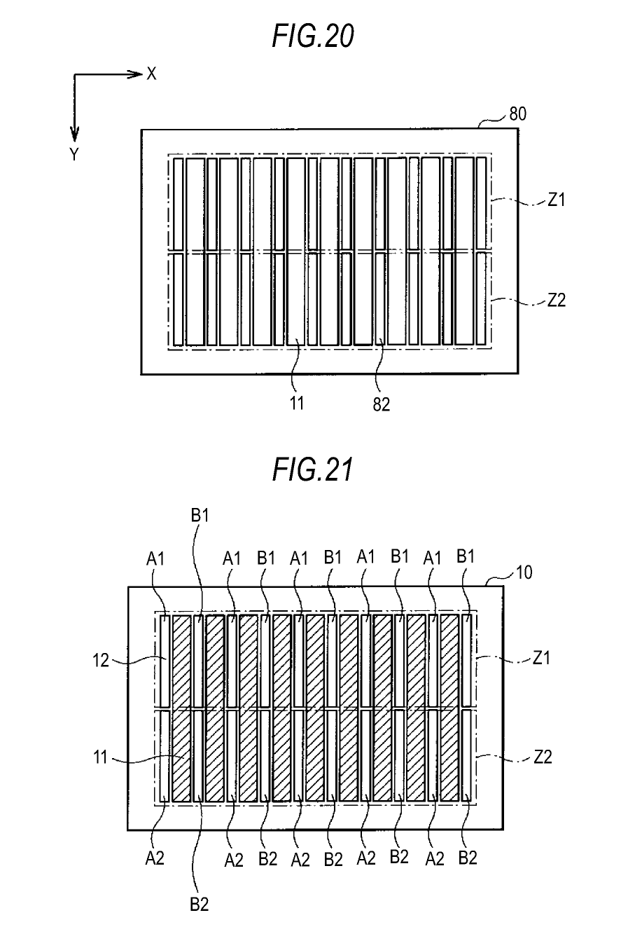

FIG. 20 shows an example of the configuration of the liquid crystal barrier 80. The liquid crystal barrier 80 includes open/close units 82. The open/close units 82 correspond to the open/close units 12 in the liquid crystal barrier 10 according to the first embodiment described above. Sections Z1 and Z2 are so set in the liquid crystal barrier 80 that they are arranged in the y-axis direction (line sequential scanning direction), and the open/close units 82 and the open/close units 11 are alternately arranged in the x-axis direction in each of the sections.

In the liquid crystal barrier 80, the open/close units 82 disposed in the section Z1 and the open/close units 82 disposed in the section Z2 can operate independent of each other. The barrier driver 41 drives the open/close units 82 disposed in the different sections independent from each other, whereby the timing at which the open/close units 82 in the section Z1 are opened or closed and the timing at which the open/close units 82 in the section Z2 are opened or closed can differ from each other in the stereoscopic display mode.

FIG. 21 shows an example of grouping of the open/close units 82. In each of the sections Z1 and Z2, the open/close units 82 form two groups in this example. Specifically, in the section Z1, a plurality of open/close units 82 that are arranged at every other location form a group A1, and the rest of the open/close units 82 that are arranged at every other location form a group B1. Similarly, in the section Z2, a plurality of open/close units 82 that are arranged at every other location form a group A2, and the rest of the open/close units 82 that are arranged at every other location form a group B2.

The barrier driver 41 drives the open/close units 82 that belong to the same group in such a way that they are opened or closed at the same timing in the stereoscopic display mode. Specifically, in the section Z1, the barrier driver 41 drives the open/close units 82 that belong to the group A1 and the open/close units 82 that belong to the group B1 in such a way that they are alternately opened or closed in a time division manner. Similarly, in the section Z2, the barrier driver 41 drives the open/close units 82 that belong to the group A2 and the open/close units 82 that belong to the group B2 in such a way that they are alternately opened or closed in a time division manner.

In the following description, the open/close units 82 that belong to the groups A1 and A2 are collectively called open/close units 82A as appropriate. Similarly, the open/close units 82 that belong to the groups B1 and B2 are collectively called open/close units 82B as appropriate.

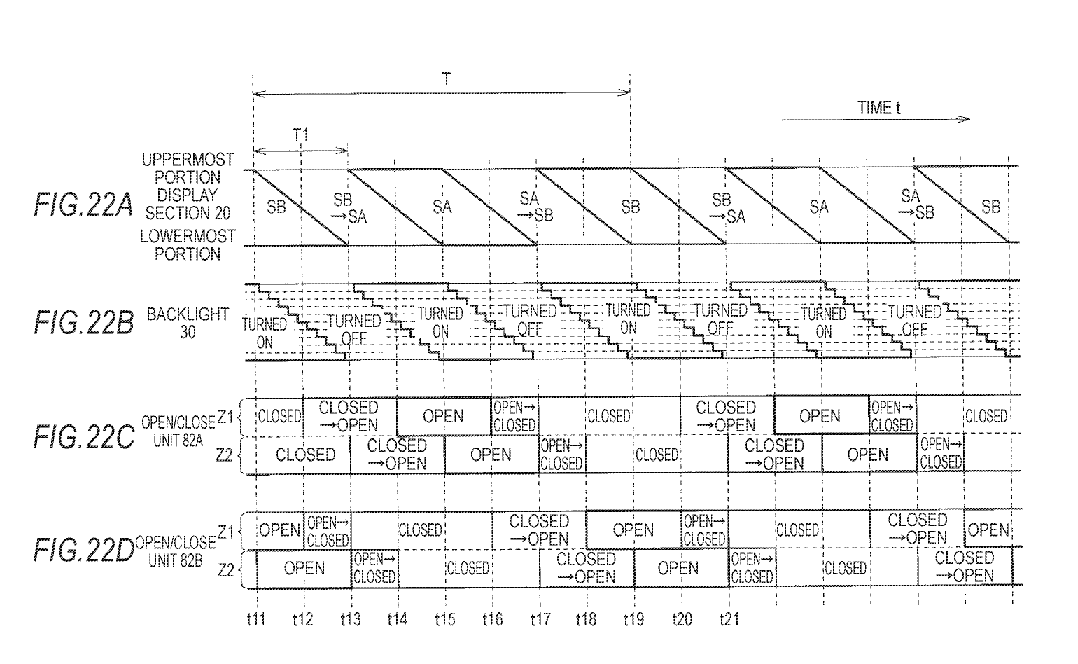

FIGS. 22A to 22D are timing charts showing how the stereoscopic display apparatus 4 displays video images. FIG. 22A shows how the display section 20 operates. FIG. 22B shows how the backlight 30 operates. FIG. 22C shows how the open/close units 82A in the liquid crystal barrier 80 operate. FIG. 22D shows how the open/close units 82B in the liquid crystal barrier 80 operate.

FIGS. 22C and 22D show how the open/close units 82A and 82B in each of the sections Z1 and Z2 operate. That is, in FIG. 22C, “open,” “open→closed,” “closed,” and “closed→open” shown in the portion corresponding to the section Z1 represent how the open/close units 82A in the section Z1 (open/close units 82 that belong to group A1) operate, and “open,” “open→closed,” “closed,” and “closed→open” shown in the portion corresponding to the section Z2 represent how the open/close units 82A in the section Z2 (open/close units 82 that belong to group A2) operate. Similarly, in FIG. 22D, “open,” “open→closed,” “closed,” and “closed→open” shown in the portion corresponding to the section Z1 represent how the open/close units 82B in the section Z1 (open/close units 82 that belong to group B1) operate, and “open,” “open→closed,” “closed,” and “closed→open” shown in the portion corresponding to the section Z2 represent how the open/close units 82B in the section Z2 (open/close units 82 that belong to group B2) operate.

First, from a timing t11 to a timing t13, the display section 20 performs line sequential scanning, and the display based on the video image signal SB is changed to the display based on the video image signal SA (FIG. 22A). In the backlight 30, the light emitters BL1 to BL10 are sequentially turned off in synchronization with the line sequential scanning in the display section 20 (FIG. 22B). In the liquid crystal barrier 80, the open/close units 82A in the section Z1 start changing their states from the closed state to the open state at a timing t12 (FIG. 22C), and the open/close units 82A in the section Z2 starts changing their states from the closed state to the open state at a timing t13 (FIG. 22C).

Thereafter, from the timing t13 to a timing t15, the display section 20 performs line sequential scanning and displays video images based on the video image signal SA (FIG. 22A). In the backlight 30, the light emitters BL1 to BL10 are sequentially turned on and start emitting light having emitted light intensities based on the emitted light intensity data 44 in synchronization with the line sequential scanning in the display section 20 (FIG. 22B). From the timing 15 to a timing t17, the display section 20 performs line sequential scanning, and the display based on the video image signal SA is changed to the display based on the video image signal SB (FIG. 22A). In the backlight 30, the light emitters BL1 to BL10 are sequentially turned off in synchronization with the line sequential scanning in the display section 20 (FIG. 22B). In the liquid crystal barrier 80, from a timing t14 to a timing t16, the open/close units 82A in the section Z1 are kept open and then change their states from the open state to the closed state (FIG. 22C). From the timing t15 to the timing t17, the open/close units 82A in the section Z2 are kept open and then change their states from the open state to the closed state (FIG. 22C). On the other hand, the open/close units 82B in the section Z1 start changing their states from the closed state to the open state at the timing t16 (FIG. 22D), and the open/close units 82B in the section Z2 start changing their states from the closed state to the open state at the timing t17 (FIG. 22D).

Thereafter, from the timing t17 to a timing t19, the display section 20 performs line sequential scanning and displays video images based on the video image signal SB (FIG. 22A). In the backlight 30, the light emitters BL1 to BL10 are sequentially turned on and start emitting light having emitted light intensities based on the emitted light intensity data 44 in synchronization with the line sequential scanning in the display section 20 (FIG. 22B). From the timing 19 to a timing t21, the display section 20 performs line sequential scanning, and the display based on the video image signal SB is changed to the display based on the video image signal SA (FIG. 22A). In the backlight 30, the light emitters BL1 to BL10 are sequentially turned off in synchronization with the line sequential scanning in the display section 20 (FIG. 22B). In the liquid crystal barrier 80, from a timing t18 to a timing t20, the open/close units 82B in the section Z1 are kept open and then change their states from the open state to the closed state (FIG. 22D). From the timing t19 to the timing t21, the open/close units 82B in the section Z2 are kept open and then change their states from the open state to the closed state (FIG. 22D). On the other hand, the open/close units 82A in the section Z1 start changing their states from the closed state to the open state at the timing t20 (FIG. 22C), and the open/close units 82A in the section Z2 start changing their states from the closed state to the open state at the timing t21 (FIG. 22C).

The stereoscopic display apparatus 4 repeats the operation described above to alternately display video images through the open/close units 82A (based on video image signal SA) and video images through the open/close units 82B (based on video image signal SB).

In the stereoscopic display apparatus 4, since the open/close units 82 are provided in the sections Z1 and Z2 arranged in the y-axis direction and the open/close units 82 in the section Z1 and the open/close units 82 in the section Z2 are configured to operate independent from each other, the period during which the open/close units 82 are open (open period) can be lengthened, whereby the brightness across the display surface can be increased.

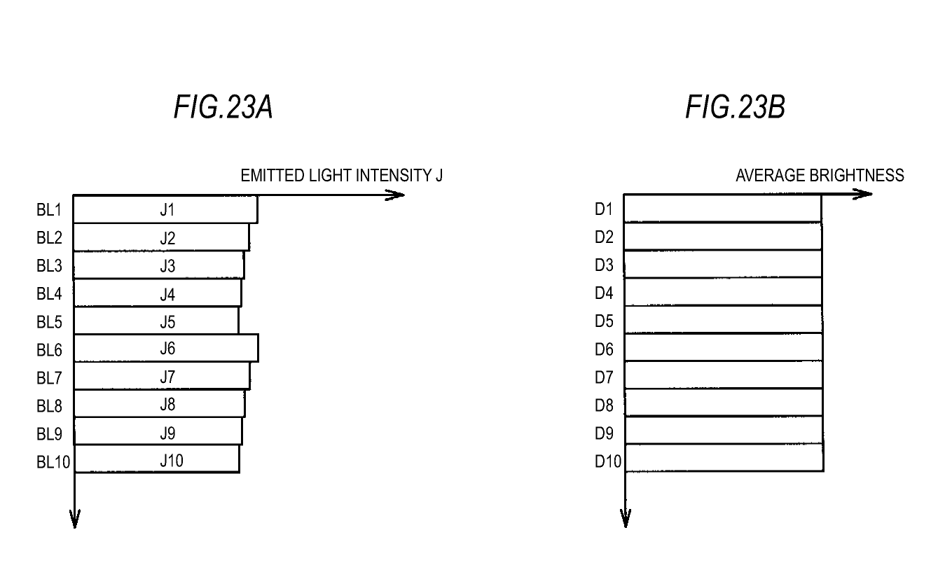

FIGS. 23A and 23B show the relationship between the intensities and the brightness levels in the stereoscopic display apparatus 4 at the time of white display. FIG. 23A shows emitted light intensities J1 to J10 of the light emitters BL1 to BL10, and FIG. 23B shows average intensity levels in the display areas D1 to D10. The backlight driver 42 sets the emitted light intensities J1 to J10 of the light emitters BL1 to BL10 in the backlight 30 based on the emitted light intensity data 44 held in the emitted light intensity data holder 43, for example, as shown in FIG. 23A. As a result, the average brightness levels in the display areas D1 to D10 at the time of white display can be substantially uniform, as shown in FIG. 23B. The reason why FIG. 23A shows a large difference between the emitted light intensities J5 and J6 is that the open/close units 82 in the section Z1 and the open/close units 82 in the section Z2 operate independent from each other at different timings.

As described above, in the present embodiment, since the open/close units 82 are provided in the sections Z1 and Z2 arranged in the line sequential scanning direction and the open/close units 82 in the section Z1 and the open/close units 82 in the section Z2 are operated independent from each other, the period during which the open/close units 82 are open can be lengthened, whereby the brightness across the display surface can be increased. Other advantageous effects are the same as those in the first and second embodiments described above.

### [Variation 4-1]

In the embodiment described above, the liquid crystal barrier 80 including the open/close units 82 is used with the stereoscopic display apparatus 1 according to the first embodiment, but the liquid crystal barrier 80 is not limited to be used with the stereoscopic display apparatus 1. Instead, for example, the liquid crystal barrier 80 may be used with the stereoscopic display apparatus 2 according to the second embodiment or the stereoscopic display apparatus 3 according to the third embodiment.

### [Variation 4-2]

In the embodiment described above, the two sections are arranged in the y-axis direction and the open/close units 82 are provided in each of the two sections, but the number of sections is not limited to two. For example, three or more sections may be arranged in the y-axis direction.

The present disclosure has been described with reference to several embodiments and variations, but the present disclosure is not limited thereto, and a variety of changes can be made thereto.

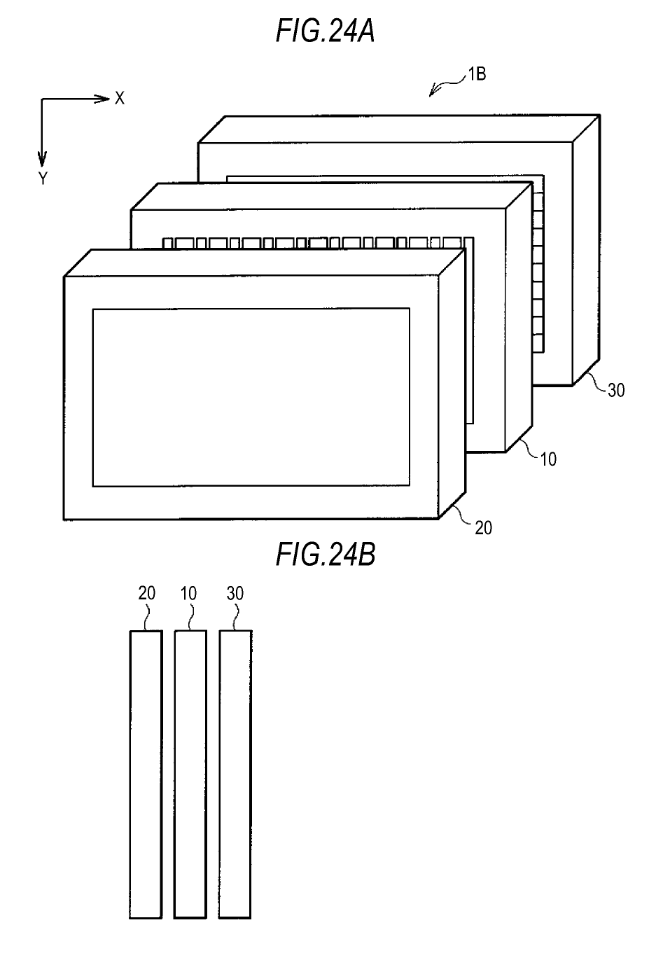

For example, in the embodiments and variations described above, the backlight 30, the display section 20, and the liquid crystal barrier 10 are disposed in this order in the stereoscopic display apparatus, but the order is not limited thereto. Instead, for example, they may be disposed in the following order: the backlight 30, the liquid crystal barrier 10, and the display section 20 as shown in FIGS. 24A and 24B.

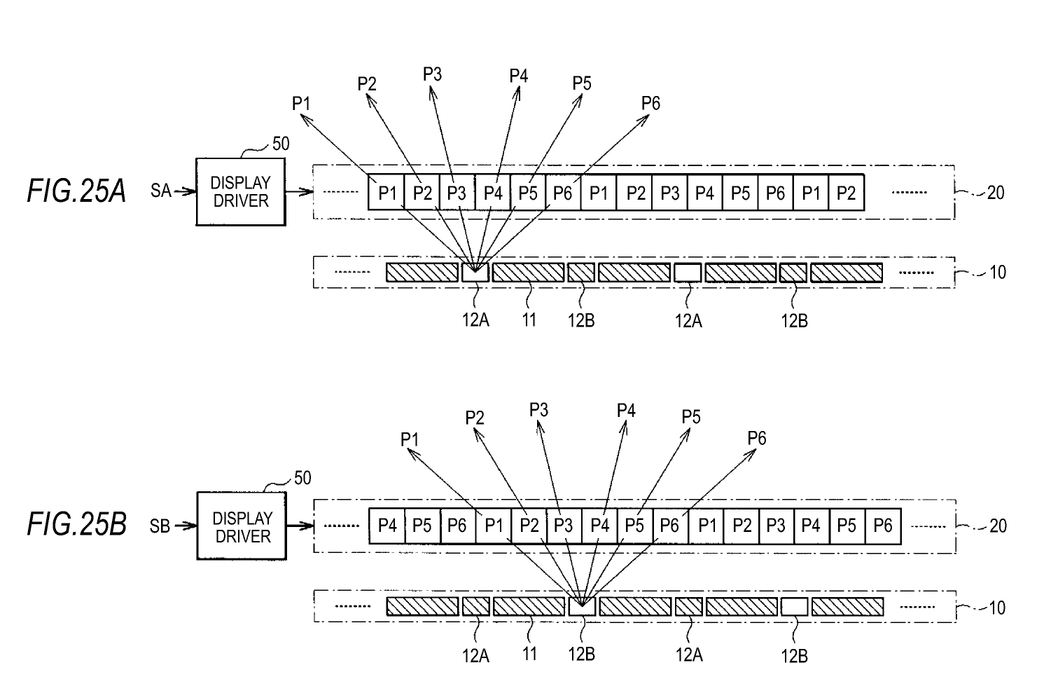

FIGS. 25A and 25B show an example of how the display section 20 and the liquid crystal barrier 10 according to the present variation operate. FIG. 25A shows a case where the video image signal SA is supplied, and FIG. 25B shows a case where the video image signal SB is supplied. In the present variation, the light emitted from the backlight 30 is first incident on the liquid crystal barrier 10. The portion of the light that passes through the open/close units 12A and 12B is then modulated by the display section 20 and outputted as six viewpoint video images.

Further, for example, in the embodiments and variations described above, the backlight is divided only in the line sequential scanning direction (y-axis direction) of the display section 20, but the division direction is not limited thereto. A backlight may be divided not only in the y-axis direction but also in the x-axis direction.

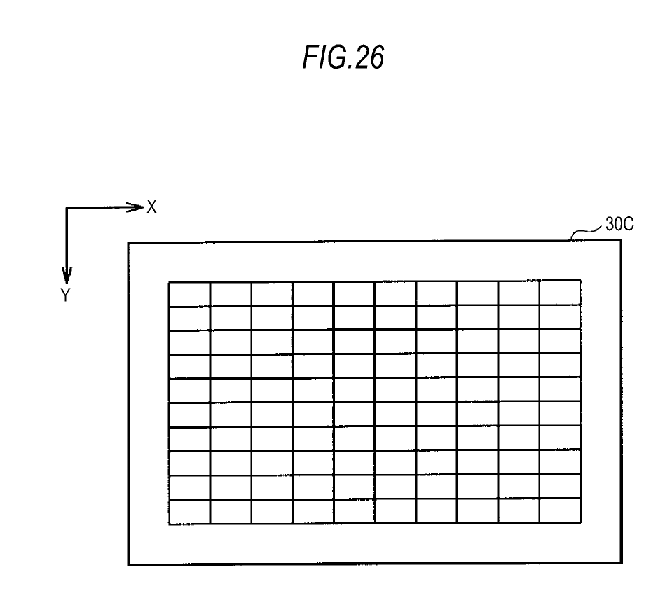

FIG. 26 shows an example of the configuration of a backlight 30C divided both in the x-axis and y-axis directions. In this example, the backlight is divided into ten in the x-axis and another ten in the y-axis directions. Such a backlight has been often used to reduce the power consumption, for example, when video images to be displayed cause one-half the image screen to be dark. In this case, the power consumption can be reduced by lowering the intensity of the portion of the backlight that corresponds to the dark area or turning off the portion of the backlight. Using such a backlight still allows the same advantageous effects as those provided by the embodiments described above to be provided. That is, controlling each set of ten light emitters in the x-axis direction simultaneously and controlling the ten sets of light emitters in the y-axis direction independently as shown in FIG. 26 allow the same advantageous effects as those provided by the embodiments described above to be provided.

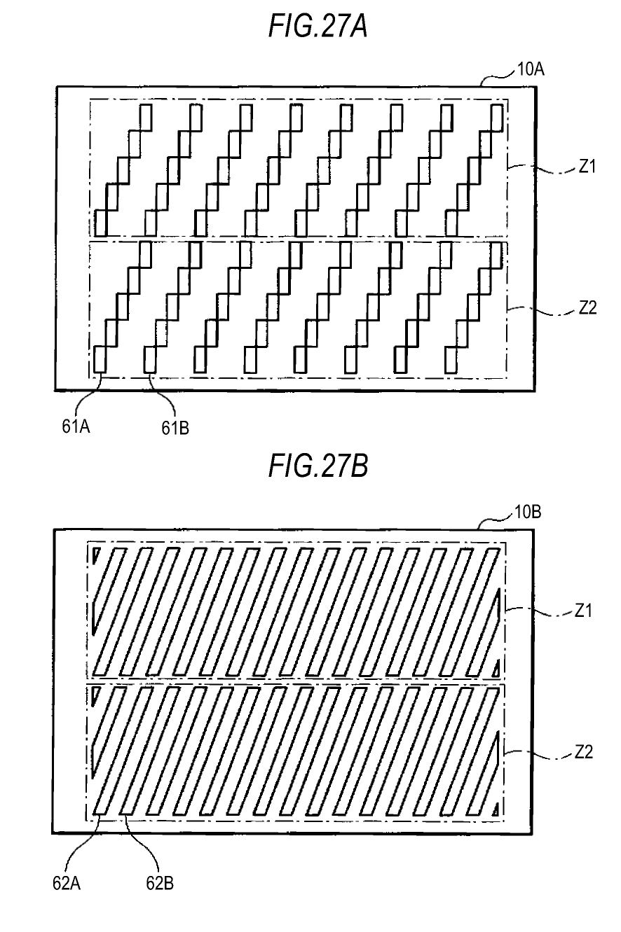

Further, for example, in the embodiments and variations described above, the open/close units in the liquid crystal barrier extend in the y-axis direction, but the open/close units does not necessarily extend in the y-axis direction. Instead, for example, the open/close units may be arranged in a step barrier form shown in FIG. 27A or in an oblique barrier form shown in FIG. 27B. JP-A-2004-264762 describes an example of the step barrier form, and JP-A-2005-86506 describes an example of the oblique barrier form.

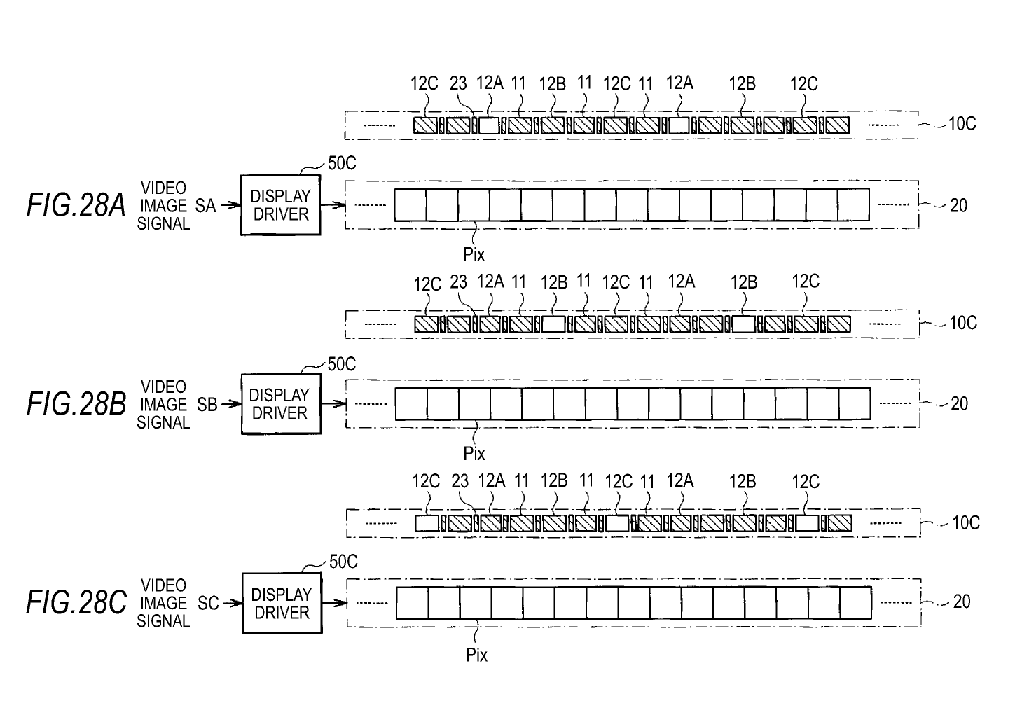

Further, for example, in the embodiments and variations described above, the open/close units 12 form the two groups, but the number of groups is not limited to two. Instead, for example, the open/close units 12 may form three or more groups. In this case, the display resolution can be further improved. FIGS. 28A to 28C show a case where the open/close units 12 form three groups A, B, and C. As in the embodiments described above, open/close units 12A represent open/close units 12 that belong to the group A, open/close units 12B represent open/close units 12 that belong to the group B, and open/close units 12C represent open/close units 12 that belong to the group C. The stereoscopic display apparatus according to the variation can achieve resolution three times higher than that achieved in the case where only the open/close units 12A are provided by alternately opening the open/close units 12A, 12B, and 12C to display video images in a time division manner. In other words, the resolution of the stereoscopic display apparatus according to the variation is only reduced to one-half (=1/6×3) the resolution achieved in the two-dimensional display.

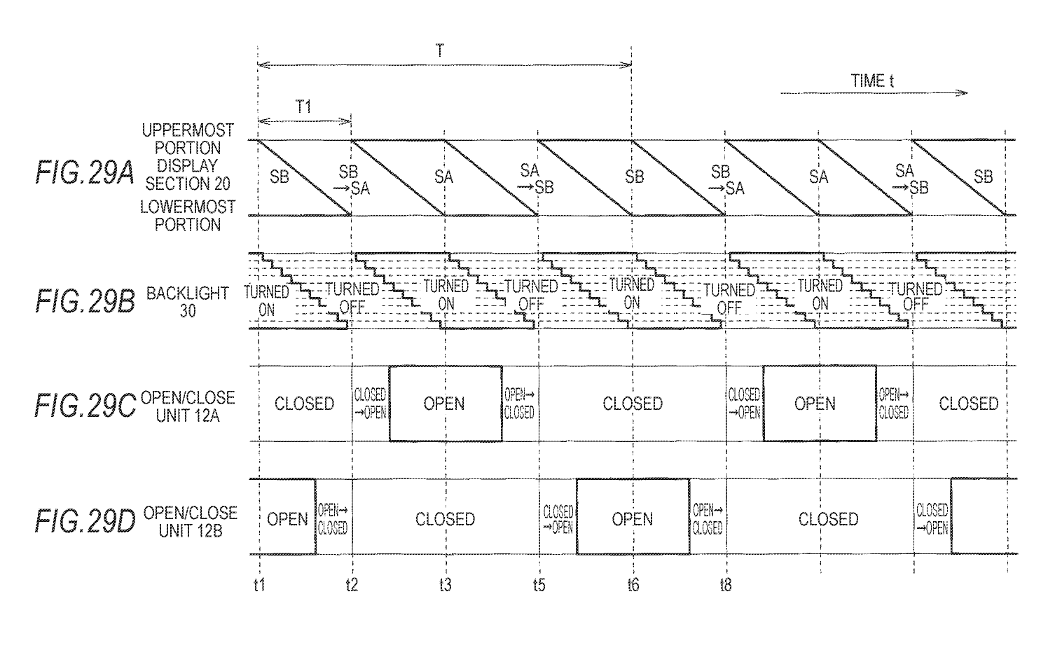

Further, for example, in the embodiments and variations described above, the liquid crystal barrier 10 is based on a liquid crystal material but is not necessarily configured this way. FIGS. 29A to 29D show how a barrier 10E including open/close units that respond faster operates. In the barrier 10E, open/close units 12A change their states from the closed state to the open state in a shorter response time in the period from a timing t2 to a timing t3 and change their states from the open state to the closed state in a shorter response time in the period from the timing t3 to a timing t5. Similarly, open/close units 12B change their states from the closed state to the open state in a shorter response time in the period from the timing t5 to a timing t6 and change their states from the open state to the closed state in a shorter response time in the period from the timing t6 to a timing t8. In this process, the majority of the period during which the backlight 30 emits light overlaps with the period during which the open/close units 12 are open. The amount of correction on the emitted light intensities J based on the emitted light intensity data 44 can therefore be reduced.

Further, for example, in the embodiments and variations described above, the display section 20 is based on a liquid crystal material but is not necessarily configured this way.

Further, for example, in the embodiments and variations described above, the backlight 30 is turned on and off in synchronization with the line sequential scanning in the display section 20 as shown in FIGS. 10A to 10D but is not necessarily configured this way. Instead, the period during which the backlight 30 emits no light may be shortened or lengthened to the extent that the viewer does not recognize degradation in image quality.

Further, for example, in the embodiments and variations described above, each of the video image signals SA and SB contains six viewpoint video images, but the number of viewpoint video images is not limited to six. Alternatively, each of the video image signals SA and SB may contain five or fewer viewpoint video images or seven or greater viewpoint video images. In this case, the relationship between the open/close units 12A and 12B in the liquid crystal barrier 10 and the pixels Pix shown in FIGS. 8A to 8C also changes. That is, for example, when each of the video image signals SA and SB contains five viewpoint video images, the open/close units 12A are desirably provided at a ratio of one open/close unit 12A to five pixels Pix in the display section 20, and similarly, the open/close units 12B are desirably provided at a ratio of one open/close unit 12B to five pixels Pix in the display section 20.

Further, for example, in the embodiments and variations described above, no light leaks from the light emitter BL1 to the light emitter BL2 in the backlight 30 and vice versa. The light emitters BL are not necessarily configured this way, but light may leak between the light emitters, for example, to the extent that image quality is not significantly degraded. As described in the above embodiments, the light emitted from each of the light emitters in the backlight desirably does not leak into the other light emitters, otherwise image quality could be degraded. Specifically, for example, when light that leaks from the light emitter BL2 is incident on the light emitter BL1 in FIGS. 5A and 5B, the light emitted from the light emitter BL1 lasts longer than it should. In this case, however, when the amount of light leakage from the light emitter BL2 is smaller than the amount of light outputted from the light emitter BL1, image quality is not significantly degraded, and stereoscopic display can be achieved.

The present disclosure contains subject matter related to that disclosed in Japanese Priority Patent Application JP 2010-250698 filed in the Japan Patent Office on Nov. 9, 2010, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A display apparatus comprising:
a display section that is driven to perform line sequential scanning and display a plurality of different viewpoint video images;
a backlight that includes a plurality of sub-light emitting areas separated in the line sequential scanning direction;
a light barrier that has a plurality of open/close unit groups each of which is formed of a plurality of open/close units, the open/close units in different groups opened or closed at different timings; and
a backlight controller that controls light emission from the sub-light emitting areas in the backlight in synchronization with the line sequential scanning in the display section,
wherein the backlight controller separately controls intensities of the light emitted from the sub-light emitting areas.

2. The display apparatus according to claim 1,
wherein the intensity of the light emitted from each of the sub-light emitting areas is set in accordance with the temporal relationship between a period during which the corresponding open/close unit is open and a period during which the sub-light emitting area emits light.

3. The display apparatus according to claim 2,
wherein the intensity of light emitted from each of the sub-light emitting areas is so set that when uniform video images are displayed in the display section and a viewer views the video images displayed by the display apparatus, the viewer recognizes uniform brightness across a display surface.

4. The display apparatus according to claim 1,
wherein the plurality of open/close units are so disposed to extend in the line sequential scanning direction, and the open/close unit groups are alternately arranged in a direction that intersects the line sequential scanning direction.

5. The display apparatus according to claim 4,
wherein the plurality of open/close units are separated in the line sequential scanning direction and form different open/close unit groups, and
the temporal relationship is a relationship between a period during which each of the open/close units is open and a period during which the sub-light emitting area corresponding to the position of the open/close unit emits light.

6. The display apparatus according to claim 1,
wherein the light barrier opens or closes the open/close units on the open/close unit group basis in a time division manner, and
the display section sequentially displays video images in positions corresponding to the open/close units that are open.

7. The display apparatus according to claim 1,
wherein the backlight controller controls the intensity of the light emitted from each of the sub-light emitting areas based on a light emission duty ratio.

8. The display apparatus according to claim 1,
further comprising an intensity parameter set holder that holds one or more intensity parameter sets used to set the intensities of the light emitted from the plurality of sub-light emitting areas.

9. The display apparatus according to claim 8,
further comprising a temperature sensor,
wherein the backlight controller selects one of the plurality of intensity parameter sets based on a detection result from the temperature sensor and controls the intensity of the light emitted from each of the sub-light emitting areas based on the selected intensity parameter set.

10. The display apparatus according to claim 8,
further comprising a temperature sensor; and
a light barrier controller that controls open/close operation of each of the open/close unit groups in the light barrier,
wherein the light barrier controller controls a timing at which each of the open/close unit groups is opened or closed based on a detection result from the temperature sensor.

11. The display apparatus according to claim 1,
wherein the period during which each of the open/close units is open includes
a first transition period during which the state of the open/close unit changes from a blocking state to an open state,
a fully open period during which the open/close unit is kept open, and
a second transition period during which the state of the open/close unit changes from the open state to the blocking state, and
the intensity of the light emitted from each of the plurality of sub-light emitting areas is set in accordance with the length of the first transition period, the length of the fully open period, the length of the second transition period, how optical transmittance of the open/close unit changes in the first transition period, and how the optical transmittance of the open/close unit changes in the second transition period.

12. The display apparatus according to claim 1,
wherein the display section is disposed between the backlight and the light barrier.

13. The display apparatus according to claim 1,
wherein the light barrier is disposed between the backlight and the display section.

14. A display apparatus comprising:
a display section that is driven to perform line sequential scanning and display a plurality of different viewpoint video images;
a backlight that includes a plurality of sub-light emitting areas separated in the line sequential scanning direction;
a light barrier that includes a plurality of open/close units, light transmittance of each of which is changed when the viewpoint video images are changed;
a backlight controller that controls light emission from the sub-light emitting areas in the backlight in synchronization with the line sequential scanning in the display section,
wherein the backlight controller separately controls intensities of the light emitted from the sub-light emitting areas.

15. A display apparatus comprising:
a display section that is driven to perform line sequential scanning and display a plurality of different viewpoint video images;
a backlight that includes a plurality of sub-light emitting areas separated in the line sequential scanning direction; and
a backlight controller that controls light emission from the backlight,
wherein the backlight includes a sub-light emitting area that emits light having an intensity different from intensities of light emitted from the other sub-light emitting areas.

16. The display apparatus according to claim 15,
wherein the backlight controller controls the intensity of light emitted from each of the sub-light emitting areas based on a light emission duty ratio.

17. The display apparatus according to claim 15,
wherein the backlight includes a sub-light emitting area having light sources different in number from those in the other sub-light emitting areas.

18. The display apparatus according to claim 15,
further comprising a temperature sensor; and
a light barrier controller that controls open/close operation of each open/close unit group in the light barrier,
wherein the light barrier controller controls a timing at which each of the open/close unit groups is opened or closed based on a detection result from the temperature sensor.

19. A display method for a display apparatus, the method comprising:
opening or closing a plurality of open/close units in a light barrier on an open/close unit group basis in a time division manner;
displaying a plurality of different viewpoint video images in positions corresponding to the open/close units that are open by performing line sequentially scanning; and
causing a plurality of sub-light emitting areas in a backlight separated in the line sequential scanning direction to emit light having individually set emitted light intensities in synchronization with the line sequential scanning.
